(19) United States
(12) Patent Application Publication
(10) Pub. No.: US 2026/0065782 A1
(43) Pub. Date: Mar. 5, 2026

(54) PLATOON INTENT MESSAGES FOR DYNAMIC PRICING OF HIGH OCCUPANCY LANES (HOL)

(71) Applicant: Toyota Motor Engineering & Manufacturing North America,Inc., Plano, TX (US)

(72) Inventors: Rohit Gupta, Santa Clara, CA (US); Ahmadreza Moradipari, Mountain View, CA (US); Sergei S. Avedisov, Mountain View, CA (US)

(73) Assignees: Toyota Motor Engineering & Manufacturing North America,Inc., Plano, TX (US); Toyota Jidosha Kabushiki Kaisha, Toyota-shi (JP)

(21) Appl. No.: 18/818,413

(22) Filed: Aug. 28, 2024

(51) Int. Cl. G08G 1/00; B60W 30/165; G08G 1/0967; G08G 1/0968; H04W 4/46

(52) U.S. Cl. CPC G08G 1/22; B60W 30/165; G08G 1/096725; G08G 1/096791; G08G 1/096805; H04W 4/46; B60W 2556/65

(57) ABSTRACT

Systems and methods are provided for platoon formation. The systems and methods may receive a platoon intent message from a first vehicle. A first location, first destination, and first high occupancy lane (HOL) price of the first vehicle may be determined from the platoon intent message. A second vehicle with a second platoon intent message comprising a second location and second destination that are within a location threshold and destination threshold of the first location and first destination of the first vehicle may be identified. A second HOL price of the second vehicle based on the second platoon intent message may be determined. It may be determined that the first HOL price of the first vehicle and the second HOL price of the second vehicle are above a price threshold. Upon such a determination, a platoon between the first and second vehicles may be established.

### TECHNICAL FIELD

The present disclosure relates generally to vehicles, and more particularly some aspects of the systems and methods disclosed herein relate to platoon formation for vehicles.

### BACKGROUND OF THE INVENTION

Roadways serve numerous essential purposes that underpin the functioning of modern society. Roads are regularly used to facilitate the transportation of people and goods through vehicles, which may include automobiles, trucks, motorcycles, bicycles, scooters, mopeds, recreational vehicles and other like on-or off-road vehicles. Vehicles may further include autonomous, semi-autonomous and manual vehicles.

With numerous vehicles traveling on roads at any given time, it may be efficient for vehicles traveling in the same direction to travel together via platooning. While there are numerous benefits to platooning, current programs have difficulty with accurately identifying vehicles and properly forming a platoon of vehicles according to conditions and features for efficient platoon formation. Current programs also have difficulty accounting for high occupancy lanes (HOLs), i.e., lanes that require a minimum number of persons present in a vehicle for its use and/or lanes that require payment for its use, when identifying vehicles to form a platoon. With modern highways and high speed roads including HOLs, accurately identifying and establishing a platoon of vehicles that are able to use such HOLs may improve the benefits and efficiency in platooning.

### BRIEF SUMMARY OF THE DISCLOSURE

According to various aspects of the disclosed technology, systems and methods for platoon formation are provided. In accordance with some implementations, a method for platoon formation of a plurality of vehicles is provided. The method may include: receiving, from a first vehicle, a platoon intent message; determining, from the platoon intent message, a first location, first destination, and first high occupancy lane (HOL) price of the first vehicle; identifying a second vehicle based on a second platoon intent message indicating a second location and second destination that are within a location threshold and destination threshold of the first location and first destination of the first vehicle; determining a second HOL price of the second vehicle based on the second platoon intent message; and upon a determination that the first HOL price of the first vehicle and the second HOL price of the second vehicle are above a price threshold, establishing a platoon between the first and second vehicles.

In some applications, the location threshold, destination threshold, and price threshold are based on at least one of the first vehicle, second vehicle, road traveled on by the first and second vehicles, time of day, day of week, traffic, road conditions, and environmental conditions.

In some applications, establishing a platoon includes generating a platoon formation strategy for the first and second vehicles, wherein the platoon formation strategy includes one or more instructions for each vehicle to execute to establish the platoon.

In some applications, the method may further include generating a platoon route for the platoon of vehicles to execute, wherein the platoon route includes a route for the platoon of vehicles to follow to reach at least one destination of the vehicles in the platoon.

In some applications, the platoon route is generated according to at least one factor of safety, energy efficiency, road capacity, or comfort.

In some applications, at least one of the factors of safety, energy efficiency, and road capacity is based on capabilities of the vehicles in the platoon and the location of the platoon of vehicles.

In some applications, the method may further include determining a HOL is available for the platoon to travel on; determining each vehicle in the platoon is in consensus to travel on the HOL; and updating the platoon route for the platoon to travel on the HOL.

In some applications, determining each vehicle in the platoon is in consensus to travel on the HOL may include: identifying a current price of the HOL; and determining each vehicle in the platoon has a respective HOL price that exceeds the current price of the HOL, wherein each vehicle's HOL price decreases as the platoon travels on the HOL.

In some applications, the method may further include determining a vehicle in the platoon is to disengage from the platoon; and updating a platoon formation strategy for each remaining vehicle in the platoon to execute to reestablish the platoon upon separation of the disengaged vehicle.

In another aspect, a system for platoon formation is provided that may include one or more processors; and memory coupled to the one or more processors to store instructions, which when executed by the one or more processors, may cause the one or more processors to perform operations. The operations may include: receiving, from a first vehicle, a platoon intent message; determining, from the platoon intent message, a first location, first destination, and first high occupancy lane (HOL) price of the first vehicle; identifying a second vehicle based on a second platoon intent message indicating a second location and second destination that are within a location threshold and destination threshold of the first location and first destination of the first vehicle; determining a second HOL price of the second vehicle based on the second platoon intent message; and upon a determination that the first HOL price of the first vehicle and the second HOL price of the second vehicle are above a price threshold, establishing a platoon between the first and second vehicles.

In some applications, the location threshold, destination threshold, and price threshold are based on at least one of the first vehicle, second vehicle, road traveled on by the first and second vehicles, time of day, day of week, traffic, road conditions, and environmental conditions.

In some applications, establishing a platoon includes generating a platoon formation strategy for the first and second vehicles, wherein the platoon formation strategy includes one or more instructions for each vehicle to execute to establish the platoon.

In some applications, the system may further include operations comprising generating a platoon route for the platoon of vehicles to execute, wherein the platoon route includes a route for the platoon of vehicles to follow to reach at least one destination of the vehicles in the platoon.

In some applications, the platoon route is generated according to at least one factor of safety, energy efficiency, road capacity, or comfort.

In some applications, at least one of the factors of safety, energy efficiency, and road capacity is based on capabilities of the vehicles in the platoon and the location of the platoon of vehicles.

In some applications, the system may further include operations comprising determining a HOL is available for the platoon to travel on; determining each vehicle in the platoon is in consensus to travel on the HOL; and updating the platoon route for the platoon to travel on the HOL.

In some applications, determining each vehicle in the platoon is in consensus to travel on the HOL may include: identifying a current price of the HOL; and determining each vehicle in the platoon has a respective HOL price that exceeds the current price of the HOL, wherein each vehicle's HOL price decreases as the platoon travels on the HOL.

In some applications, the system may further include operations comprising determining a vehicle in the platoon is to disengage from the platoon; and updating a platoon formation strategy for each remaining vehicle in the platoon to execute to reestablish the platoon upon separation of the disengaged vehicle.

In another aspect, a non-transitory machine-readable medium is provided. The non-transitory computer-readable medium may include instructions that when executed by a processor may cause the processor to perform operations including: receiving, from a first vehicle, a platoon intent message; determining, from the platoon intent message, a first location, first destination, and first high occupancy lane (HOL) price of the first vehicle; identifying a second vehicle based on a second platoon intent message indicating a second location and second destination that are within a location threshold and destination threshold of the first location and first destination of the first vehicle; determining a second HOL price of the second vehicle based on the second platoon intent message; and upon a determination that the first HOL price of the first vehicle and the second HOL price of the second vehicle are above a price threshold, establishing a platoon between the first and second vehicles.

In some applications, the location threshold, destination threshold, and price threshold are based on at least one of the first vehicle, second vehicle, road traveled on by the first and second vehicles, time of day, day of week, traffic, road conditions, and environmental conditions.

In some applications, establishing a platoon includes generating a platoon formation strategy for the first and second vehicles, wherein the platoon formation strategy includes one or more instructions for each vehicle to execute to establish the platoon.

In some applications, the non-transitory machine-readable medium may further include operations comprising generating a platoon route for the platoon of vehicles to execute, wherein the platoon route includes a route for the platoon of vehicles to follow to reach at least one destination of the vehicles in the platoon.

In some applications, the platoon route is generated according to at least one factor of safety, energy efficiency, road capacity, or comfort.

In some applications, at least one of the factors of safety, energy efficiency, and road capacity is based on capabilities of the vehicles in the platoon and the location of the platoon of vehicles.

In some applications, the non-transitory machine-readable medium may further include operations comprising determining a HOL is available for the platoon to travel on; determining each vehicle in the platoon is in consensus to travel on the HOL; and updating the platoon route for the platoon to travel on the HOL.

In some applications, determining each vehicle in the platoon is in consensus to travel on the HOL may include: identifying a current price of the HOL; and determining each vehicle in the platoon has a respective HOL price that exceeds the current price of the HOL, wherein each vehicle's HOL price decreases as the platoon travels on the HOL.

In some applications, the non-transitory machine-readable medium may further include operations comprising determining a vehicle in the platoon is to disengage from the platoon; and updating a platoon formation strategy for each remaining vehicle in the platoon to execute to reestablish the platoon upon separation of the disengaged vehicle.

Other features and aspects of the disclosed technology will become apparent from the following detailed description, taken in conjunction with the accompanying drawings, which illustrate, by way of example, the features in accordance with applications of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various applications, is described in detail with reference to the following figures. The figures are provided for purposes of illustration only and merely depict typical or example applications.

FIG. 1 illustrates an example computing system for platoon formation, according to example applications described in the present disclosure.

FIG. 2 illustrates an example vehicle with which applications of the disclosed technology may be implemented.

FIG. 3 illustrates an example system for platoon formation, according to example applications described in the present disclosure.

FIG. 4 illustrates an example process for platoon formation, according to example applications described in the present disclosure.

FIG. 5 illustrates an example platoon intent message for platoon formation, according to example applications described in the present disclosure.

FIG. 6 illustrates an example diagram for platoon formation, according to example applications described in the present disclosure.

FIG. 7 illustrates an example computing component that includes one or more hardware processors and machine-readable storage media storing a set of machine-readable/machine-executable instructions that, when executed, cause the one or more hardware processors to perform an illustrative method for platoon formation, according to example embodiments described in the present disclosure.

FIG. 8 is an illustration of an example computing component that may be used to implement various features of embodiments described in the present disclosure.

The figures are not exhaustive and do not limit the present disclosure to the precise form disclosed.

### DETAILED DESCRIPTION

As described above, roads may be used as a means of facilitating vehicular transportation for personal, commercial, industrial, governmental, and other purposes. Vehicles may include automobiles, trucks, motorcycles, bicycles, scooters, mopeds, recreational vehicles and other like on-or off-road vehicles. Vehicles may further include autonomous, semi-autonomous and manual vehicles. Roads may include public and private infrastructure elements on which vehicles may travel, such as streets, arteries, highways, alleyways, easements, parking lots, and other. Roads may also include a high occupancy lane(s), i.e., a lane that requires a minimum number of persons present in a vehicle for its use and/or a lane that requires payment for its use.

Aspects of the technology disclosed herein may provide systems and methods configured to format a platoon of vehicles. More particularly, some aspects of the technology may provide systems and methods for platoon formation of vehicles traveling in a same direction. This may include, for example, receiving platoon intent messages from one or more vehicles, analyzing each platoon intent message to determine a location, destination, and high occupancy lane (HOL) price of each vehicle, identifying vehicles with respective locations, destinations, and HOL prices that are close to one another, and establishing a platoon between vehicles with respective locations, destinations, and HOL prices that are close to one another. This may present an improvement over conventional technology that have difficulty with accurately identifying vehicles and properly forming a platoon of vehicles according to conditions and features for efficient platoon formation. The presented systems and methods for platoon formation may also present improvements over conventional technology that have difficulty accounting for high occupancy lanes (HOLs), i.e., lanes that require a minimum number of persons present in a vehicle for its use and/or lanes that require payment for its use, when identifying vehicles to form a platoon. With modern highways and high speed roads including HOLs, accurately identifying and establishing a platoon of vehicles that are able to use such HOLs may improve the benefits and efficiency in platooning.

An ego vehicle may be traveling on a road. The ego vehicle may collect sensor data of the road upon which the ego vehicle is traveling. The ego vehicle may include, for example, an automobile, truck, motorcycle, bicycle, scooter, moped, recreational vehicle and other like on- or off-road vehicles. The ego vehicle may include, for example, an autonomous, semi-autonomous and manual operation.

The ego vehicle may include one or more sensors that may be used to collect sensor data and map data of the road. The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). Data may be received from at least one sensor of the ego vehicle. The sensor data may include information on the condition of the road, damages to the road, hazardous features on the road, attributes of the road (i.e., the color, size, type and shape of lane markers, number of lanes, etc.), types of lanes (i.e., high occupancy lanes, merging lanes, exiting lanes, passing lanes, slow lanes, turning lanes, etc.), environmental conditions, lane markers and markings within the lane, map, location, traffic, speed, direction, and objects on, proximate to, and associated with the road that is collected by the ego vehicle. An object on the road may include a pothole, crack, tire marking, faded road marking, debris, occlusion, road reflection, flooding, ice, fire, oil leak, uneven pavement, erosion, raveling, sign, pole, building, structure, pedestrian, animal, and vehicle. The environmental condition may include location, coordinates, population, landscape, landmark, terrain, territory, weather, temperature, humidity, pollution, habitat, and other environmental surroundings on, proximate to, or associated with the road that the ego vehicle is traveling on.

The ego vehicle may collect map data of the road that the ego vehicle is traveling on. The map data, which may be stored onboard the vehicle or obtained from the cloud or other infrastructure element, may include location, coordinates, population, landscape, landmark, terrain, territory, weather, temperature, humidity, pollution, habitat, and other environmental surroundings on, proximate to, and associated with the road that the ego vehicle is traveling on. The map data, sensor data or both may be analyzed to determine a position of the ego vehicle on the road.

The ego vehicle may generate and send a platoon intent message to a platoon formation system. The platoon intent message may be a message presenting the ego vehicle's intention to seek to join a platoon of vehicles. The platoon intent message of the ego vehicle may include a location of the ego vehicle (i.e., information associated with the precise position of the ego vehicle on the road it is traversing on), destination of the ego vehicle (i.e., information associated with the precise position of the destination that the ego vehicle is traveling to reach), high occupancy lane (HOL) price (i.e., a maximum, total dollar amount that the ego vehicle may be able or willing to spend to travel on a high occupancy lane), and driving preference of the ego vehicle (i.e., information associated with the preference of the driver of the ego vehicle, including, for example, an average speed of travel, maximum speed of travel, maximum number of vehicles in a platoon, etc.). The ego vehicle may use one or more sensors to determine its location, destination, HOL price, and driving preference. The ego vehicle may use one or more forms of communication to send the platoon intent message to the platoon formation system.

Upon receiving the platoon intent message from the ego vehicle, the platoon formation system may determine the location, destination, and HOL price of the ego vehicle. The location of the ego vehicle may include information associated with the precise position of the ego vehicle on the road it is traversing on. The location of the ego vehicle may be determined according to a GPS of the ego vehicle. The destination of the ego vehicle may include information associated with the precise position of the destination that the ego vehicle is traveling to reach as its final destination. The destination of the ego vehicle may be determined according to a GPS of the ego vehicle. The high occupancy lane (HOL) price may include information associated with a maximum, total dollar amount that the ego vehicle may be able or willing to spend to travel on a high occupancy lane while traveling in a platoon of vehicles.

One or more vehicles may send a respective platoon intent message to the platoon formation system, presenting each vehicle's intention to join a platoon of vehicles. Each platoon intent message of a vehicle may include a location, destination, HOL price, and driving preference of the respective vehicle.

After receiving the platoon intent message of the ego vehicle, the platoon formation system may identify one or more vehicles at one or more locations within a distance threshold from the location of the ego vehicle. The platoon formation system may identify such one or more vehicles at one or more locations within a distance threshold from the location of the ego vehicle by analyzing the platoon intent message of each of the one or more vehicles. The distance threshold may be a maximum distance between the location of the ego vehicle and the location of another vehicle. The distance threshold may be a preset value. The distance threshold may vary according to one or more factors, including, for example, time of day, day of week, location of the ego vehicle, type of road the ego vehicle is traveling on, traffic on the road, road conditions, environmental conditions, etc. The distance threshold may vary according to conditions and features of the road as determined from sensor data of one or more vehicles, including, for example, the ego vehicle and the second vehicle. The distance threshold may be updated according to algorithms and models using driving data of vehicles. Many variations are possible.

After determining a set of one or more vehicles at one or more locations within the distance threshold away from the location of the ego vehicle, the platoon formation system may determine which vehicles of the set of one or more vehicles has a destination of travel that is within a destination threshold of the destination of the ego vehicle. The destination threshold may be a maximum distance between the destination of the ego vehicle and the destination of another vehicle. The destination threshold may be a maximum distance between the destination of the ego vehicle and the route of travel of the another vehicle to the destination of the another vehicle, and vice versa. Many variations are possible. The destination threshold may be a preset value. The destination threshold may vary according to one or more factors, including, for example, time of day, day of week, destination of the ego vehicle, type of road the ego vehicle is traveling on, route of the ego vehicle, traffic on the road, road conditions, environmental conditions, etc. The destination threshold may vary according to conditions and features of the road as determined from sensor data of one or more vehicles, including, for example, the ego vehicle and the second vehicle. The destination threshold may be updated according to algorithms and models using driving data of vehicles. Many variations are possible.

Amongst the subset of one or more vehicles that are determined to be within the location threshold and destination threshold from the ego vehicle, the platoon formation system may identify one or more vehicles that have a respective HOL price that is above a price threshold. The price threshold may be a minimum dollar value amount to be used for traveling on a HOL on the road. The price threshold may be a preset value. The price threshold may vary according to one or more factors, including, for example, time of day, day of week, destination of the ego vehicle, type of road the ego vehicle is traveling on, route of the ego vehicle, traffic on the road, road conditions, environmental conditions, etc. The price threshold may vary according to conditions and features of the road as determined from sensor data of one or more vehicles, including, for example, the ego vehicle and the second vehicle. The price threshold may be updated according to algorithms and models using driving data of vehicles. Many variations are possible.

The one or more vehicles from the subset of vehicles determined to have a respective HOL price that is above the price threshold may be instructed to form a platoon with the ego vehicle by the platoon formation system. To establish a platoon between the ego vehicle and one or more vehicles, the platoon formation system may generate platoon formation strategy. The platoon formation strategy may include instructions for each vehicle to execute to establish a platoon. The platoon formation system may send the platoon formation strategy to each vehicle involved in forming a platoon. Each vehicle determined to form a platoon may execute instructions from the platoon formation strategy to establish the platoon. Each vehicle may have its own set of instructions to execute to efficiently and effectively form the platoon. Each vehicle may be assigned a particular position in the platoon, such as, for example, a lead position, following position, middle position, end position, first position, second position, third position, etc. The position assigned to each vehicle determined to form a platoon may be assigned at random by the platoon formation system. The position assigned to each vehicle determined to form a platoon may be based on one or more factors, including, for example, driving preference of each vehicle, location of each vehicle, destination of each vehicle, HOL price of each vehicle, etc. The driving preference of a vehicle may include information associated with the preference of the driver of the vehicle, including, for example, an average speed of travel, maximum speed of travel, position in a platoon that the driver of the vehicle is comfortable with being at, etc.

Each vehicle may have its own sensor data. The sensor data of each vehicle may include a direction, speed, driving pattern, location, road condition, map, location, traffic, object, and environmental condition that the respective vehicle encountered during its travel on the road. Each vehicle in the platoon may have one or more sensors capable of collecting data of the road and the driving performance of the respective vehicle. One or more sensors, either individually or in combination, may be able to collect data on the road, such as sensor data, to determine conditions and features of the road. The one or more sensors, either individually or in combination, may be able to collect data on the driving performance of the respective vehicle to determine the driving pattern of the respective vehicle on the road. The one or more sensors of the vehicle used to collect data may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS).

Upon the ego vehicle and one or more other vehicles forming a platoon, the platoon formation system may send the vehicles a platoon route for each vehicle in the platoon to execute. The platoon formation system may generate the platoon route to include a route for each vehicle in the platoon to follow to reach at least one destination of the vehicles in the platoon. The platoon route may be generated according to one or more factors, including, for example, time of day, day of week, destination of one or more vehicles in the platoon, type of road the platoon of vehicles is traveling on, traffic on the road, road conditions, environmental conditions, safety, energy efficiency, road capacity, comfort, etc. The safety factor may be associated with a minimum amount of safety conditions that the vehicles in a platoon may have to follow when traveling as a platoon, including, for example, a minimum distance of space between each vehicle in the platoon based on the speed of the platoon, maximum speed of travel allowed by each vehicle in the platoon, minimum distance of space between the lead vehicle of the platoon and the vehicle in front of the platoon, etc. The energy efficiency factor may be associated with an amount of energy that each vehicle in the platoon may need to conserve when traveling in the platoon. The road capacity factor may be associated with a number of vehicles on the road and near the location of the platoon of vehicles. The comfort factor may be associated with at least one of driving preferences of each driver of each vehicle in the platoon, capabilities of each vehicle in the platoon, road conditions, environmental conditions, traffic, etc. Each factor considered in generating the platoon route may be based on capabilities of each vehicle in the platoon, the location of the platoon of vehicles, characteristics of the road, environmental conditions, etc. The platoon formation system may update the platoon route according to changes in the one or more factors. The platoon formation system may send the updated platoon route to each vehicle in the platoon.

After a platoon of vehicles is formed, the platoon of vehicles may travel on the road according to the platoon route generated by the platoon formation system. The platoon formation system may determine there is a HOL available on the road for the platoon to travel on. The HOL may be determined by the platoon formation system from sensor data of any of the vehicles in the platoon. The platoon formation system may determine the presence of a HOL from sensor data of any vehicle on the road where the HOL is present. The platoon formation system may determine the presence of a HOL from GPS data of the road. Many variations are possible.

Once a HOL is determined to be available on the road the platoon is traveling on, the platoon formation system may determine whether each vehicle in the platoon is in consensus to travel on the HOL. To determine whether each vehicle in the platoon is in consensus, the platoon formation system may identify a current price of the HOL. The current price of the HOL may be a monetary value that a vehicle may be charged when traveling on the HOL for a particular amount of time or distance or both. Using the current price of the HOL, the platoon formation system may determine the respective HOL price of each vehicle in the platoon. The HOL price of a vehicle may be a maximum monetary value or budget that the vehicle may spend on fees to use a HOL. The HOL price of a vehicle may be a total monetary value that is available for use to pay for fees with using a HOL. Many variations are possible. For example, a platoon of four vehicles may have a first vehicle with a HOL price of $10.00, a second vehicle with a HOL price $11.25, a third vehicle with a HOL price of $9.50, and a fourth vehicle with a HOL price of $10.75. If the platoon formation system determines that the respective HOL price of each vehicle in the platoon is greater than or exceeds the current price of the HOL, then the platoon formation system may update the platoon route to instruct the platoon of vehicles to travel on the HOL on the road. For example, if the current price of the HOL is $1.25 for each 2 miles of travel, and a platoon of four vehicles have respective HOL prices of $10.00, $11.25, $9.50, and $10.75, then each vehicle in the platoon is determined to have a respective HOL price that exceeds the current price of the HOL and the platoon formation system may determine that each vehicle in the platoon is in consensus with traveling on the HOL on the road.

As a vehicle travels on a HOL, the vehicle's HOL price may decrease according to costs incurred from traveling on the HOL. When a vehicle's HOL price decreases to a value that is less than a current price of a HOL, the platoon formation system may determine that the vehicle is not in consensus to travel on the HOL. When at least one vehicle in a platoon is not in consensus with traveling on the HOL on a road, the platoon formation system may generate a platoon route for the platoon to travel on the road using a regular lane and not a HOL. When at least one vehicle in a platoon is in consensus to travel on a HOL and at least one vehicle in the platoon is not in consensus to travel on the HOL, the platoon formation system may provide instructions to the vehicles in the platoon to disengage from the platoon formation. This may cause each vehicle to be independent from one another and no longer receive and execute instructions of travel from the platoon formation system. When at least two vehicles in a platoon is in consensus to travel on a HOL and at least one vehicle in the platoon is not in consensus to travel on the HOL, the platoon formation system may provide instructions to the vehicles not in consensus to disengage from the platoon formation. This may cause the vehicles not in consensus to be independent from the other vehicles remaining in the platoon and to no longer receive and execute instructions of travel from the platoon formation system. Many variations are possible.

A vehicle in a platoon may disengage from the platoon for a variety of reasons, including, for example, when the vehicle is not in consensus with traveling on a HOL while other vehicles in the platoon are in consensus, when the vehicle reaches a point in the platoon route where it needs to disengage and separate itself to reach its respective destination, when the vehicle has to make a stop (e.g., to refill gas, recharge vehicle battery, purchase food, use restroom, take rest stop, fix vehicle, buy medicine, etc.), and when the driver of the vehicle chooses to no longer be in the platoon. A vehicle in a platoon may disengage from the platoon by sending a platoon disengage message to the platoon formation system. The platoon formation system may disengage a vehicle from a platoon by sending instructions to the vehicle for disengaging from the platoon. The platoon formation system may disengage a vehicle from a platoon without first receiving a platoon disengage message, when the platoon formation system determines that the vehicle needs to be disengaged from the platoon based on the platoon intent message of the vehicle. Many variations are possible.

When a vehicle in a platoon is determined to be disengaged from the platoon, the platoon formation system may send instructions to the disengaging vehicle to disengage from the platoon formation. The platoon formation system may generate an updated platoon formation strategy for each remaining vehicle in the platoon and send the updated platoon formation strategy to each remaining vehicle. Each remaining vehicle may execute the updated platoon formation strategy to establish an updated platoon formation upon the separation of the disengaged vehicle. In one example, if the third vehicle in a four vehicle platoon is determined to disengage from the platoon, an updated platoon formation strategy may be provided to have the remaining vehicles establish an updated platoon formation where the fourth vehicle will now move closer to the second vehicle and take the place of the disengaged third vehicle. The updated platoon formation may now consist of only the remaining three vehicles. In another example, if the first vehicle in a four vehicle platoon is determined to disengage from the platoon, an updated platoon formation strategy may be provided to have the remaining vehicles establish an updated platoon formation where the second vehicle becomes the lead vehicle of the platoon and takes the place of the disengaged first vehicle. The updated platoon formation may now consist of only the remaining three vehicles. Once the remaining vehicles have established the updated platoon formation, the updated platoon may continue traveling on the road according to the platoon route provided by the platoon formation system.

Each of the vehicles in a platoon may communicate to one another and to the platoon formation system using a P2P (peer-to-peer), V2V or other communication protocol. A platoon of vehicles may move together according to a navigation strategy (i.e., a platoon route) to travel efficiently, effectively, and safely navigate the platoon of vehicles on a road.

Monitoring data of various vehicles traveling on a road may permit up-to-date navigation information and road conditions, that may be analyzed to efficiently and accurately identify compatible vehicles for platoon formation and navigate a platoon of vehicles on a road. The efficient and accurate determination of compatible vehicles may improve the efficiency, effectiveness, and safety of forming platoons of vehicles and in the navigation of platoons of vehicles traveling on the road. Efficiently, effectively, and safely controlling platooning may further increase the avoidance of incidents and accidents occurring on the road.

It should be noted that the terms “accurate,” “accurately,” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

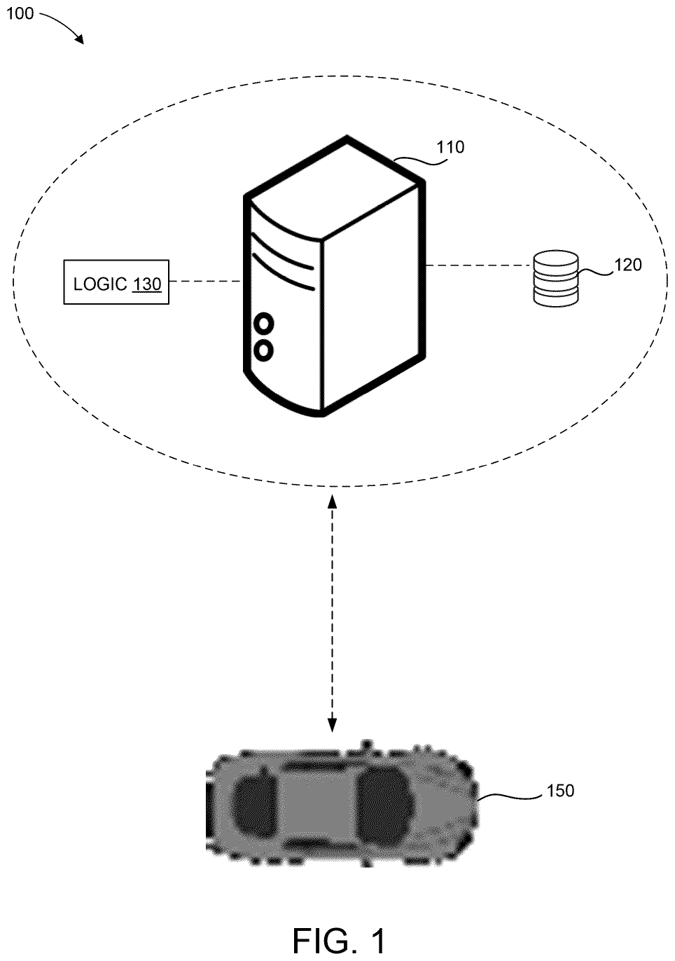

FIG. 1 illustrates an example of a computing system 100 which may be internal or otherwise associated within a vehicle 150. In some embodiments, the computing system 100 may be a machine learning (ML) pipeline and model, and use ML algorithms. In some examples, vehicle 150 may include an autonomous, semi-autonomous or manual vehicle, with which applications of the disclosed technology may be implemented. In some examples, vehicle 150 may include an automobile, truck, motorcycle, bicycle, scooter, moped, recreational vehicle and other like on-or off-road vehicles, that may include an autonomous, semi-autonomous and manual operation. In some examples, the vehicle 150 may include a computing device, such as a desktop computer, a laptop, a mobile phone, a tablet device, an Internet of Things (IoT) device, etc. The vehicle 150 may input data into computing component 110. The computing component 110 may perform one or more available operations on the input data to generate outputs, such as identifying other vehicles to form a platoon with vehicle 150. The vehicle 150 may further display the outputs on a Graphical User Interface (GUI). The GUI may be on the vehicle 150 and may display the outputs as a two-dimensional (2D) and three-dimensional (3D) layout and map showing the various outputs generated by algorithms, such as ML algorithms, based on various input data, such as vehicle location, travel destination, high occupancy lane (HOL) price budget, driving preference, sensor data of road conditions, environmental conditions, lane markers, traffic, speed of vehicles, direction of vehicles, obstructions, and objects from vehicles and roads.

The computing system 110 in the illustrated example may include one or more processors and logic 130 that implements instructions to carry out the functions of the computing component 110, such as, for example, receiving a platoon intent message from vehicle 150; determining, from the platoon intent message, a location, destination, HOL price, and driving preference of vehicle 150; identifying a second vehicle with a second platoon intent message comprising a second location and second destination of the second vehicle that are within a location threshold and destination threshold of the location and destination of vehicle 150; and upon a determination of the HOL price and driving preference of vehicle 150 being within a price threshold and driving threshold of a second HOL price and second driving preference of the second vehicle according to the second platoon intent message, establishing a platoon between vehicle 150 and the second vehicle. The computing component 110 may store, in a database 120, details regarding scenarios or conditions in which some algorithms, image datasets, and assessments are performed and used to identify vehicles to form platoons of vehicles. Some of the scenarios or conditions will be illustrated in the subsequent figures.

A processor may include one or more GPUs, CPUs, microprocessors or any other suitable processing system. Each of the one or more processors may include one or more single core or multicore processors. The one or more processors may execute instructions stored in a non-transitory computer readable medium. Logic 130 may contain instructions (e.g., program logic) executable by the one or more processors to execute various functions of computing component 110. Logic 130 may contain additional instructions as well, including instructions to transmit data to, receive data from, and interact with vehicle 150.

ML can refer to methods that, through the use of algorithms, are able to automatically extract intelligence or rules from training data sets and capture the same in informative models. In turn, those models are capable of making predictions based on patterns or inferences gleaned from subsequent data input into a trained model. According to implementations of the disclosed technology, the ML algorithm comprises, among other aspects, algorithms implementing a Gaussian process and the like. The ML algorithms disclosed herein may be supervised and/or unsupervised depending on the implementation. The ML algorithms may emulate the observed characteristics and components of roads, vehicles and drivers to better evaluate road conditions, evaluate driving patterns, and determine and identify lanes of a road to accurately navigate vehicles.

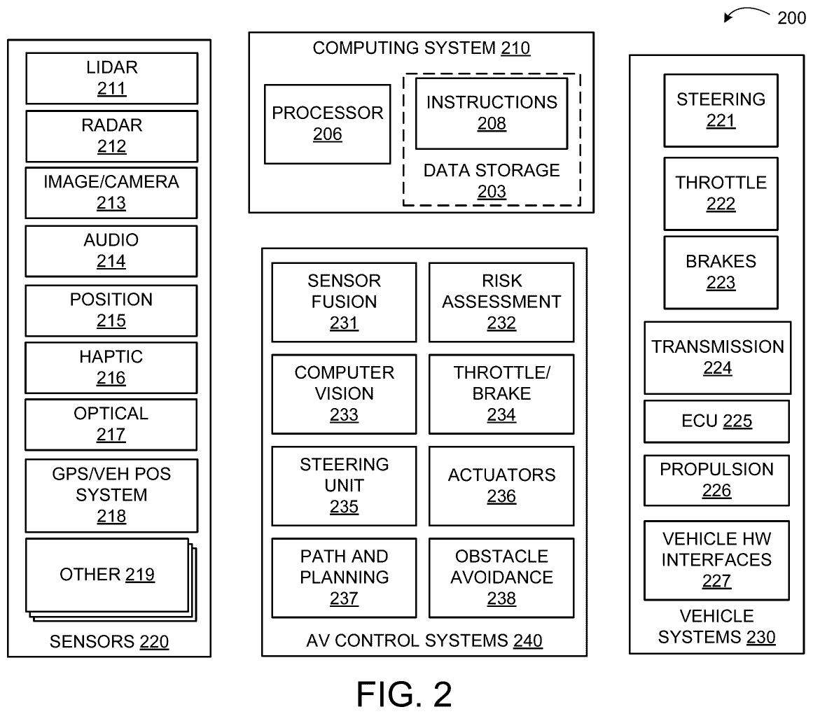

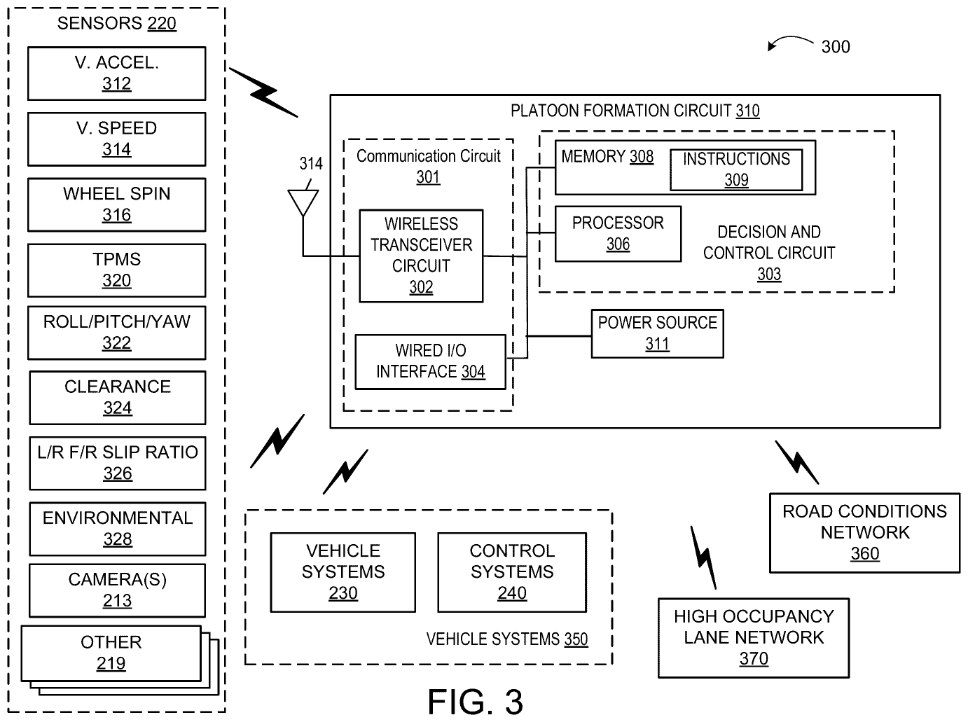

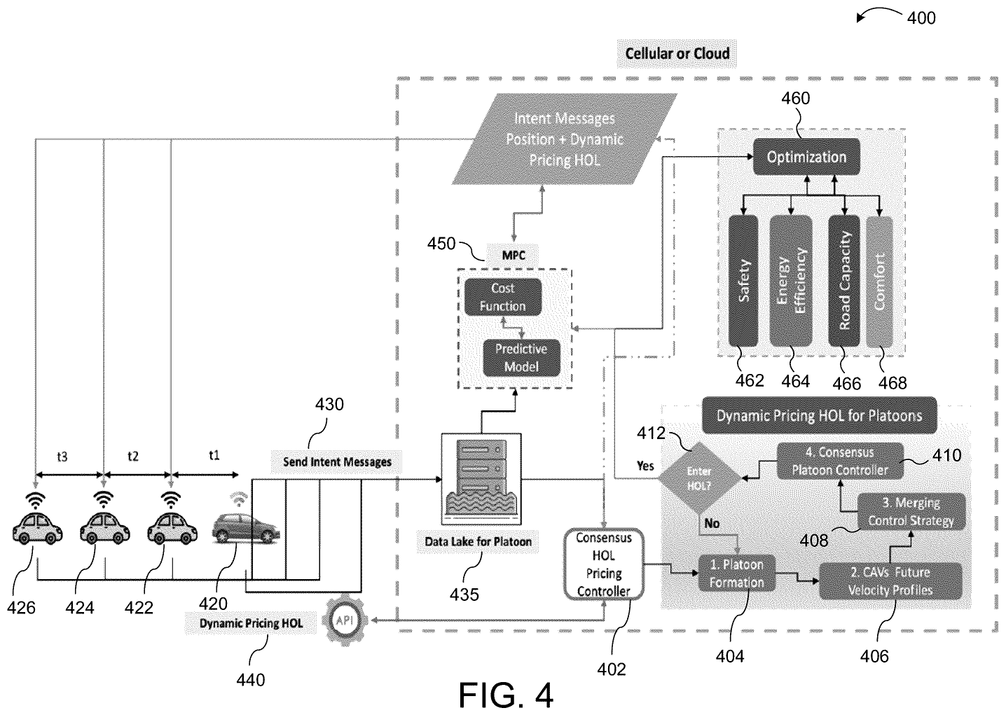

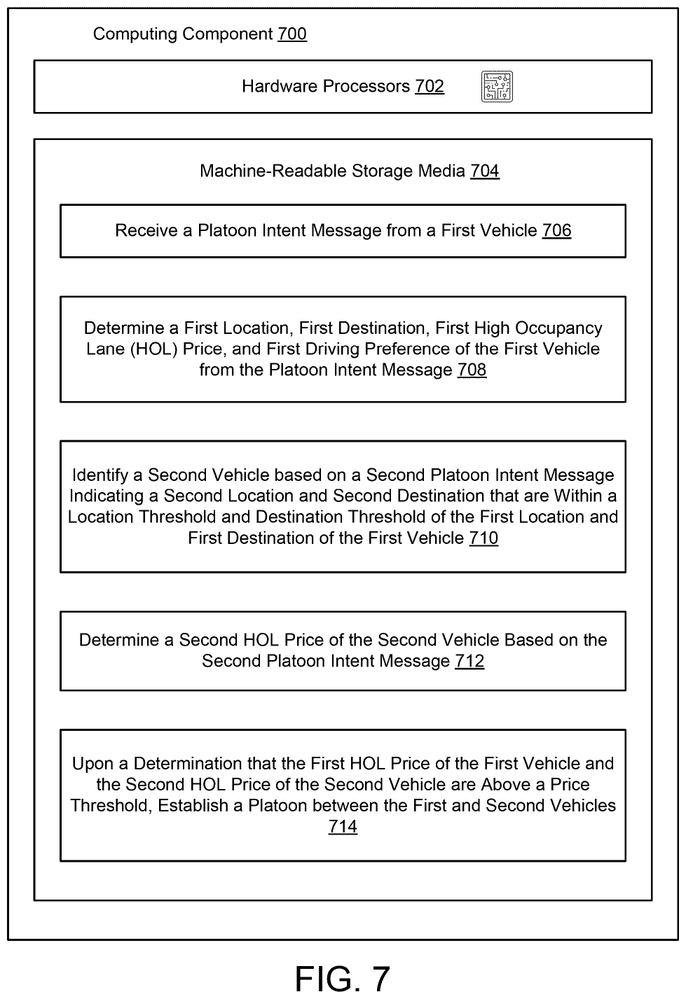

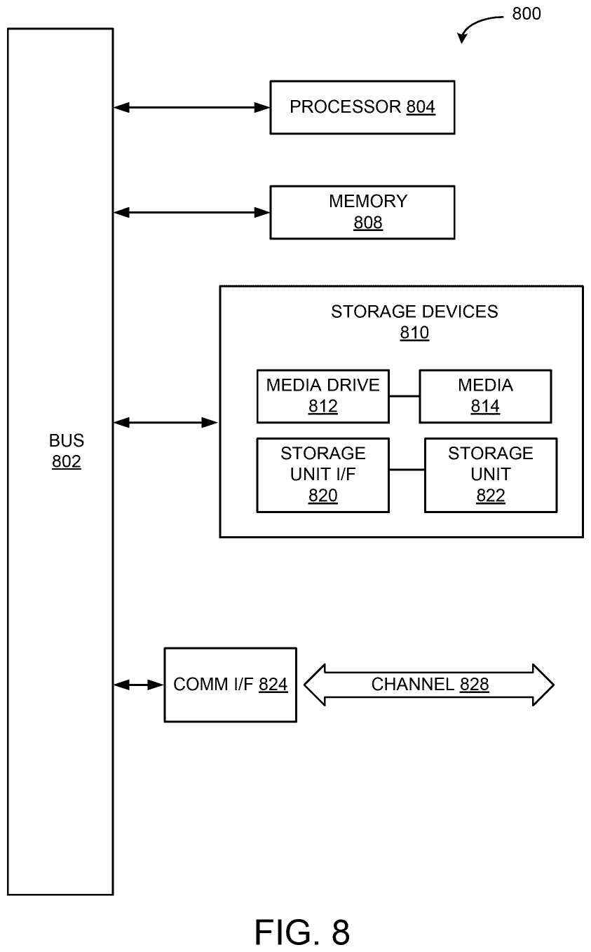

Although one example computing system 110 is illustrated in FIG. 1, in various embodiments multiple computing systems 110 can be included. Additionally, one or more systems and subsystems of computing system 100 can include its own dedicated or shared computing component 110, or a variant thereof. Accordingly, although computing system 100 is illustrated as a discrete computing system, this is for ease of illustration only, and computing system 100 can be distributed among various systems or components. The computing component 110 may be, for example, the computing system 210 of FIG. 2, the platoon formation system 300 of FIG. 3, the process 400 of FIG. 4, the computing component 700 of FIG. 7 and the computing component 800 of FIG. 8.

FIG. 2 illustrates an example connected vehicle 200, such as an autonomous, semi-autonomous or manual vehicle, with which applications of the disclosed technology may be implemented. As described herein, vehicle 200 can refer to a vehicle, such as an automobile, truck, motorcycle, bicycle, scooter, moped, recreational vehicle and other like on-or off-road vehicles, that may include an autonomous, semi-autonomous and manual operation. The vehicle 200 may include components, such as a computing system 210, sensors 220, vehicle systems 230, and AV control systems 240. Either of the computing system 210, sensors 220, vehicle systems 230, and AV control systems 240 can be part of an automated vehicle system/advanced driver assistance system (ADAS). ADAS can provide navigation control signals (e.g., control signals to actuate the vehicle and operate one or more vehicle systems 230 as shown in FIG. 2) for the vehicle to navigate a variety of situations. As used herein, ADAS can be an autonomous vehicle control system adapted for any level of vehicle control and driving autonomy. For example, the ADAS can be adapted for level 1, level 2, level 3, level 4, and level 5 autonomy (according to SAE standard). ADAS can allow for control mode blending (i.e., blending of autonomous and assisted control modes with human driver control). ADAS can correspond to a real-time machine perception system for vehicle actuation in a multi-vehicle environment. Vehicle 200 may include a greater or fewer quantity of systems and subsystems, and each could include multiple elements. Accordingly, one or more of the functions of the technology disclosed herein may be divided into additional functional or physical components, or combined into fewer functional or physical components. Additionally, although the systems and subsystems illustrated in FIG. 2 are shown as being partitioned in a particular way, the functions of vehicle 200 can be partitioned in other ways. For example, various vehicle systems and subsystems can be combined in different ways to share functionality.

Sensors 220 may include a plurality of different sensors to gather data regarding vehicle 200, its operator, its operation and its surrounding environment. Although various sensors are shown, it can be understood that systems and methods for platoon formation may not require many sensors. It can also be understood that system and methods described herein can be augmented by sensors off the vehicle 200. In this example, sensors 220 include light detection and ranging (LiDAR) sensor 211, radar sensor 212, image sensors 213 (i.e., a camera), audio sensors 214, position sensor 215, haptic sensor 216, optical sensor 217, a Global Positioning System (GPS) or other vehicle positioning system 218, and other like distance measurement and environment sensing sensors 219. One or more of the sensors 220 may gather data, such as road conditions data, and send that data to the vehicle ECU or other processing unit. Sensors 220 (and other vehicle components) may be duplicated for redundancy.

Distance measuring sensors such as LiDAR sensor 211, radar sensor 212, IR sensors and other like sensors can be used to gather data to measure distances and closing rates to various external objects such as other vehicles, roads, traffic signs, pedestrians, light poles and other objects. Image sensors 213 can include one or more cameras or other image sensors to capture images of the environment around the vehicle, such as road surfaces, as well as images internal to the vehicle. Information from image sensors 213 (e.g., camera) can be used to determine information about the environment surrounding the vehicle 200 including, for example, information regarding road surfaces and other objects surrounding vehicle 200. For example, image sensors 213 may be able to recognize specific vehicles (e.g. color, vehicle type), landmarks or other features (including, e.g., street signs, traffic lights, etc.), slope of the road, lines on the road, damages and other potentially hazardous conditions to the road, curbs, objects to be avoided (e.g., other vehicles, pedestrians, bicyclists, etc.) and other landmarks or features. Information from image sensors 213 can be used in conjunction with other information such as map data, or information from positioning system 218 to determine, refine, or verify vehicle (ego vehicle 200 or another vehicle) location as well as detect obstructions and identify lanes of a road.

Vehicle positioning system 218 (e.g., GPS or other positioning system) can be used to gather position information about a current location of the vehicle 200 as well as other positioning or navigation information, such as the positioning information about a current location and direction of movement of the vehicle 200 according to a particular road condition.

Other sensors 219 may be provided as well. Other sensors 219 can include vehicle acceleration sensors, vehicle speed sensors, wheelspin sensors (e.g., one for each wheel), a tire pressure monitoring sensor (e.g., one for each tire), vehicle clearance sensors, left-right and front-rear slip ratio sensors, and environmental sensors (e.g. to detect weather, traction conditions, or other environmental conditions). Other sensors 219 can be further included for a given implementation of ADAS. Various sensors 220, such as other sensors 219, may be used to provide input to computing system 210 and other systems of vehicle 200 so that the systems have information useful for platoon formation and navigation.

AV control systems 240 may include a plurality of different systems/subsystems to control operation of vehicle 200. In this example, AV control systems 240 can include, autonomous driving module (not shown), sensor fusion module 231, risk assessment module 232, computer vision module 233, throttle and brake control unit 234, steering unit 235, actuator(s) 236, path and planning module 237, and obstacle avoidance module 238. Sensor fusion module 231 can be included to evaluate data from a plurality of sensors, including sensors 220. Sensor fusion module 231 may use computing system 210 or its own computing system to execute algorithms to assess inputs from the various sensors.

Throttle and brake control unit 234 can be used to control actuation of throttle and braking mechanisms of the vehicle 200 to accelerate, slow down, stop or otherwise adjust the speed of the vehicle 200. For example, the throttle unit can control the operating speed of the engine or motor used to provide motive power for the vehicle 200. Likewise, the brake unit can be used to actuate brakes (e.g., disk, drum, etc.) or engage regenerative braking (e.g., such as in a hybrid or electric vehicle) to slow or stop the vehicle 200.

Steering unit 235 may include any of a number of different mechanisms to control or alter the heading of the vehicle 200. For example, steering unit 235 may include the appropriate control mechanisms to adjust the orientation of the front or rear wheels of the vehicle 200 to accomplish changes in direction of the vehicle 200 during operation. Electronic, hydraulic, mechanical or other steering mechanisms may be controlled by steering unit 235.

Computer vision module 233 may be included to process image data (e.g., image data captured from image sensors 213, or other image data) to evaluate the environment within or surrounding the vehicle 200. For example, algorithms operating as part of computer vision module 233 can evaluate still or moving images to determine features and landmarks (e.g., road pavements, lines of the road, damages and other potentially hazardous conditions on the road, road signs, traffic lights, lane markings and other road boundaries, etc.), obstacles (e.g., pedestrians, bicyclists, other vehicles, other obstructions in the path of the subject vehicle) and other objects. The system can include video tracking and other algorithms to recognize objects such as the foregoing, estimate their speed, map the surroundings, and so on. Computer vision module 233 may be able to model a road traffic vehicle network, a high occupancy lane network, predict incoming hazards and obstacles, predict road hazard, determine one or more contributing factors to identifying obstructions, and determine one or more factors for platoon formation. Computer vision module 233 may be able to perform depth estimation, image/video segmentation, camera localization, and object classification according to various classification techniques (including by applied neural networks).

Path and planning module 237 may be included to compute a desired path for vehicle 200 based on input from various other sensors and systems. For example, path and planning module 237 can use information from positioning system 218, sensor fusion module 231, computer vision module 233, obstacle avoidance module 238 (described below) and other systems (e.g., AV control systems 240, sensors 220, and vehicle systems 230) to determine a safe path to navigate the vehicle 200 along a segment of a desired route. Path and planning module 237 may also be configured to dynamically update the vehicle path as real-time information is received from sensors 220 and other control systems 240.

Obstacle avoidance module 238 can be included to determine control inputs necessary to avoid obstacles and obstructions detected by sensors 220 or AV control systems 240. Obstacle avoidance module 238 can work in conjunction with path and planning module 237 to determine an appropriate path to avoid and navigate around obstacles and obstructions.

Path and planning module 237 (either alone or in conjunction with one or more other module of AV Control system 240, such as obstacle avoidance module 238, computer vision module 233, and sensor fusion module 231) may also be configured to perform and coordinate one or more vehicle maneuvers. Example vehicle maneuvers can include at least one of a path tracking, stabilization and collision avoidance maneuver. With connected vehicles, such as vehicles selected for platoon formation, vehicle maneuvers can be performed at least partially cooperatively between the connected vehicles to gather a sufficient amount of data of the road to efficiently, effectively, and safely navigate a platoon of vehicles. A sufficient amount of data of a road may include collecting data of the characteristics of and obstructions on a road, at various angles and perspectives. Each different type of characteristic and obstruction may warrant a different amount of data to be collected and analyzed to make the needed determinations of the characteristic and obstruction. A sufficient amount of data of a road may further include environmental conditions, road conditions, lane markers, traffic, speed of vehicles, maneuvers of vehicles, and objects on or relating to a road. Hence, those of ordinary skill in the art will understand what sufficient means in the context of collecting a sufficient amount of data of a road.

Vehicle systems 230 may include a plurality of different systems/subsystems to control operation of vehicle 200. In this example, vehicle systems 230 include steering system 221, throttle system 222, brakes 223, transmission 224, electronic control unit (ECU) 225, propulsion system 226 and vehicle hardware interfaces 227. The vehicle systems 230 may be controlled by AV control systems 240 in autonomous, semi-autonomous or manual mode of vehicle 200. For example, in autonomous or semi-autonomous mode, AV control systems 240, alone or in conjunction with other systems, can control vehicle systems 230 to operate the vehicle 200 in a fully or semi-autonomous fashion. When control is assumed, computing system 210 and AV control system 240 can provide vehicle control systems to vehicle hardware interfaces for controlled systems such as steering angle 221, brakes 223, throttle 222, or other hardware interfaces 227, such as traction force, turn signals, horn, lights, etc. This may also include an assist mode in which the vehicle 200 takes over partial control or activates ADAS controls (e.g., AC control systems 240) to assist the driver with vehicle operation.

Computing system 210 in the illustrated example includes a processor 206, and memory 203. Some or all of the functions of vehicle 200 may be controlled by computing system 210. Processor 206 can include one or more GPUs, CPUs, microprocessors or any other suitable processing system. Processor 206 may include one or more single core or multicore processors. Processor 206 executes instructions 208 stored in a non-transitory computer readable medium, such as memory 203.

Memory 203 may contain instructions (e.g., program logic) executable by processor 206 to execute various functions of vehicle 200, including those of vehicle systems and subsystems. Memory 203 may contain additional instructions as well, including instructions to transmit data to, receive data from, interact with, and control one or more of the sensors 220, AV control systems 240 and vehicle systems 230. In addition to the instructions, memory 203 may store data and other information used by the vehicle 200 and its systems and subsystems for operation, including operation of vehicle 200 in the autonomous, semi-autonomous or manual modes. For example, memory 203 can include data that has been communicated to the ego vehicle (e.g. via V2V communication), mapping data, a model of the current or predicted road traffic vehicle network, vehicle dynamics data, computer vision recognition data, and other data which can be useful for the execution of one or more vehicle maneuvers, for example by one or more modules of the AV control systems 240.

Although one computing system 210 is illustrated in FIG. 2, in various applications multiple computing systems 210 can be included. Additionally, one or more systems and subsystems of vehicle 200 can include its own dedicated or shared computing system 210, or a variant thereof. Accordingly, although computing system 210 is illustrated as a discrete computing system, this is for ease of illustration only, and computing system 210 can be distributed among various vehicle systems or components.

Vehicle 200 may also include a (wireless or wired) communication system (not illustrated) to communicate with other vehicles, infrastructure elements, cloud components and other external entities using any of a number of communication protocols including, for example, V2V (vehicle-to-vehicle), V2I (vehicle-to-infrastructure) and V2X (vehicle-to-everything) protocols. Such a wireless communication system may allow vehicle 200 to receive information from other objects including, for example, map data, data regarding infrastructure elements, data regarding operation and intention of surrounding vehicles, and so on. A wireless communication system may allow vehicle 200 to receive updates to data that can be used to execute one or more vehicle control modes, and vehicle control algorithms as discussed herein. Wireless communication system may also allow vehicle 200 to transmit information to other objects and receive information from other objects (such as other vehicles, user devices, or infrastructure). In some applications, one or more communication protocol or dictionaries can be used, such as the SAE J2935 V2X Communications Message Set Dictionary. In some applications, the communication system may be useful in retrieving and sending one or more data useful in platoon formation, as disclosed herein.

Communication system can be configured to receive data and other information from sensors 220 that is used in determining whether and to what extent control mode blending should be activated. Additionally, communication system can be used to send an activation signal or other activation information to various vehicle systems 230 and AV control systems 240 as part of controlling the vehicle 200. For example, communication system can be used to send signals to one or more of the vehicle actuators 236 to control parameters, for example, maximum steering angle, throttle response, vehicle braking, torque vectoring, and so on.

In some applications, computing functions for various applications disclosed herein may be performed entirely on computing system 210, distributed among two or more computing systems 210 of vehicle 200, performed on a cloud-based platform, performed on an edge-based platform, or performed on a combination of the foregoing.

Path and planning module 237 can allow for executing one or more vehicle control mode(s), and vehicle control algorithms in accordance with various implementations of the systems and methods disclosed herein.

In operation, path and planning module 237 (e.g., by a driver intent estimation module, not shown) can receive information regarding human control input used to operate the vehicle 200. As described above, information from sensors 220, actuators 236 and other systems can be used to determine the type and level of human control input. Path and planning module 237 can use this information to predict driver action. Path and planning module 237 can use this information to generate a predicted path and model a road traffic vehicle network. This may be useful in evaluating road conditions, and navigating a platoon of vehicles. As also described above, information from sensors, and other systems can be used to evaluate road conditions, evaluate driving patterns, and navigate a platoon of vehicles on a road. Eye state tracking, attention tracking, or intoxication level tracking, for example, can be used to determine vehicle movement patterns according to inherent human behavior. It can be understood that the driver state can contribute to platoon formation as disclosed herein. Driver state can be provided to a risk assessment module 232 to determine the level of risk associated with a vehicle operation, and with joining a platoon of vehicles. Although not illustrated in FIG. 2, where the assessed risk contributes to determining vehicle movement patterns according to inherent human behaviors, a platoon formation strategy may be generated and provided to vehicle 200 to form a platoon with other vehicles. Aspects of generating a platoon formation strategy to form a platoon with various vehicles will be disclosed with reference to subsequent figures.

Path and planning module 237 can receive state information such as, for example from visibility maps, traffic and weather information, hazard maps, and local map views. Information from a navigation system can also provide a mission plan including maps and routing to path and planning module 237.

The path and planning module 237 (e.g., by a driver intent estimation module, not shown) can receive this information and predict behavior characteristics within a future time horizon. This information can be used by path and planning module 237 for executing one or more planning decisions. Planning decisions can be based on one or more policy (such as defensive driving policy). Planning decisions can be based on one or more level of autonomy, connected vehicle actions, one or more policy (such as defensive driving policy, cooperative driving policy, such as swarm or platoon formation, leader following, etc.). Path and planning module 237 can generate an expected model for the road traffic hazards and assist in creating a predicted traffic hazard level and verification strategy for vehicles to execute.

Path and planning module 237 can receive risk information from risk assessment module 232. Path and planning module 237 can receive vehicle capability and capacity information from one or more vehicle systems 230. Vehicle capability can be assessed, for example, by receiving information from vehicle hardware interfaces 227 to determine vehicle capabilities and identify a reachable set model. Path and planning module 237 can receive surrounding environment information (e.g., from computer vision module 233, and obstacle avoidance module 238). Path and planning module 237 can apply risk information and vehicle capability and capacity information to trajectory information (e.g., based on a planned trajectory and driver intent) to determine a safe or optimized trajectory for the vehicle 200 given the driver's intent, policies (e.g. safety or vehicle cooperation policies), communicated information, given one or more obstacles in the surrounding environment, and road conditions. This trajectory information can be provided to controller (e.g., ECU 225) to provide partial or full vehicle control in the event of a risk level above threshold. A signal from risk assessment module 232 can be used generate countermeasures described herein. A signal from risk assessment module 232 can trigger ECU 225 or another AV control system 240 to take over partial or full control of the vehicle 200.

FIG. 3 illustrates an example architecture for platoon formation described herein. Referring now to FIG. 3, in this example, a platoon formation system 300 includes a platoon formation circuit 310, a plurality of sensors 220, and a plurality of vehicle systems 350. Also included are various elements of road conditions network 360 and high occupancy lane network 370 with which the platoon formation system 300 can communicate. It can be understood that a road conditions network 360 can include various elements that are navigating and important in navigating a road conditions network, such as vehicles, pedestrians (with or without connected devices that can include aspects of platoon formation system 300 disclosed herein), or infrastructure (e.g. traffic signals, sensors, such as traffic cameras, databases, central servers, weather sensors). Other elements of the road conditions network 360 can include connected elements at workplaces, or the home (such as vehicle chargers, connected devices, appliances, etc.). It can be understood that a high occupancy lane network 370 can include various elements that are navigating and important in navigating a high occupancy lane network, such as location, traffic, or time (e.g. day of the week, hour of the day, etc.).

Platoon formation system 300 can be implemented as and include one or more components of the vehicle 200 shown in FIG. 2. Sensors 220, vehicle systems 350, elements of road conditions network 360, and elements of high occupancy lane network 370 can communicate with the platoon formation circuit 310 via a wired or wireless communication interface. As previously alluded to, elements of road conditions network 360 can correspond to connected or unconnected devices, infrastructure (e.g. traffic signals, sensors, such as traffic cameras, weather sensors), vehicles, pedestrians, obstacles, etc. that are in a broad or immediate vicinity of ego vehicle (e.g., vehicle 200) or otherwise important to the navigation of the road conditions network (such as remote infrastructure). Elements of high occupancy lane network 370 can correspond to connected or unconnected devices, location, traffic, time, etc. that are associated to ego vehicle (e.g., vehicle 200) or otherwise important to the navigation of high occupancy lane network (such as remote infrastructure). Although sensors 220, vehicle systems 350, road conditions network 360, and high occupancy lane network 370 are depicted as communicating with platoon formation circuit 310, they can also communicate with each other, as well as with other vehicle systems 350 and directly with elements of a road conditions network 360 and high occupancy lane network 370. Data as disclosed herein can be communicated to and from the platoon formation circuit 310. For example, various infrastructure (example element of road conditions network 360 or high occupancy lane network 370) can include one or more databases, such as vehicle crash data, weather data, or traffic data. This data can be communicated to the circuit 310, and such data can be updated based on outcomes for one or more maneuvers or navigation of the road conditions network, high occupancy lane network, vehicle telematics, driver state (physical and mental), vehicle data from sensors 220 (e.g., tire pressure or brake status) from the ego vehicle. Similarly, traffic data, vehicle state data, time of travel, demographics data for drivers can be retrieved and updated. All of this data can be included in and contribute to predictive analytics (e.g., by machine learning) of accident possibility, determinations of road conditions and poor, hazard road conditions, and determination of high occupancy lane availability and pricing. Similarly, models, circuits, and predictive analytics can be updated according to various outcomes.

Platoon formation circuit 310 can evaluate road conditions of roads and driving patterns of vehicles, detect lanes of a road, such as high occupancy lanes, and generate a platoon formation strategy to identify vehicles compatible to form a platoon as described herein. As will be described in more detail herein, the formation of a platoon of vehicles can have one or more contributing factors. Various sensors 220, vehicle systems 350, road conditions network 360, and high occupancy lane network 370 elements may contribute to gathering data for evaluating road conditions of roads, evaluating driving patterns of vehicles, and identify lanes of a road, such as high occupancy lanes. For example, the platoon formation circuit 310 can include at least one of a platoon formation detection and response circuit. The platoon formation circuit 310 can be implemented as an ECU or as part of an ECU such as, for example electronic control unit 225. In other applications, platoon formation circuit 310 can be implemented independently of the ECU, for example, as another vehicle system.

Platoon formation circuit 310 can be configured to evaluate road conditions of roads, driving patterns of vehicles, detect lanes of a road, such as high occupancy lanes, generate a platoon formation strategy to identify vehicles compatible to form a platoon to traverse to a destination of at least one vehicle, and appropriately respond. Platoon formation circuit 310 may include a communication circuit 301 (including either or both of a wireless transceiver circuit 302 with an associated antenna 314 and wired input/output (I/O) interface 304 in this example), a decision and control circuit 303 (including a processor 306 and memory 308 in this example) and a power source 311 (which can include power supply). It is understood that the disclosed platoon formation circuit 310 can be compatible with and support one or more standard or non-standard messaging protocols.

Components of platoon formation circuit 310 are illustrated as communicating with each other via a data bus, although other communication in interfaces can be included. Decision and control circuit 303 can be configured to control one or more aspects of platoon formation and response. Decision and control circuit 303 can be configured to execute one or more steps described with reference to FIG. 4 and FIG. 7.

Processor 306 can include a GPU, CPU, microprocessor, or any other suitable processing system. The memory 308 may include one or more various forms of memory or data storage (e.g., flash, RAM, etc.) that may be used to store the calibration parameters, images (analysis or historic), point parameters, instructions and variables for processor 306 as well as any other suitable information. Memory 308 can be made up of one or more modules of one or more different types of memory, and may be configured to store data and other information as well as operational instructions 309 that may be used by the processor 306 to execute one or more functions of platoon formation circuit 310. For example, data and other information can include vehicle data, such as a determined familiarity of the driver with driving and the vehicle. The data can also include values for signals of one or more sensors 220 useful in detecting and identifying vehicles compatible to form a platoon and high occupancy lanes for platoons to traverse on. Operational instruction 309 can contain instructions for executing logical circuits, models, and methods as described herein.

Although the example of FIG. 3 is illustrated using processor and memory circuitry, as described below with reference to circuits disclosed herein, decision and control circuit 303 can be implemented utilizing any form of circuitry including, for example, hardware, software, or a combination thereof. By way of further example, one or more processors, controllers, ASICS, PLAS, PALs, CPLDs, FPGAs, logical components, software routines or other mechanisms might be implemented to make up a platoon formation circuit 310. Components of decision and control circuit 303 can be distributed among two or more decision and control circuits 303, performed on other circuits described with respect to platoon formation circuit 310, be performed on devices (such as cell phones) performed on a cloud-based platform (e.g. part of infrastructure), performed on distributed elements of the road conditions network 360, such as at multiple vehicles, user device, central servers, performed on an edge-based platform, performed on distributed elements of the high occupancy lane network 370, and performed on a combination of the foregoing.

Communication circuit 301 may include either or both a wireless transceiver circuit 302 with an associated antenna 314 and a wired I/O interface 304 with an associated hardwired data port (not illustrated). As this example illustrates, communications with platoon formation circuit 310 can include either or both wired and wireless communications circuits 301. Wireless transceiver circuit 302 can include a transmitter and a receiver (not shown), e.g., a platoon formation broadcast mechanism, to allow wireless communications via any of a number of communication protocols such as, for example, WiFi (e.g. IEEE 802.11 standard), Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by platoon formation circuit 310 to/from other components of the vehicle, such as sensors 220, vehicle systems 350, infrastructure (e.g., servers cloud based systems), and other devices or elements of road conditions network 360 and high occupancy lane network 370. These RF signals can include information of almost any sort that is sent or received by the ego vehicle.

Wired I/O interface 304 can include a transmitter and a receiver (not shown) for hardwired communications with other devices. For example, wired I/O interface 304 can provide a hardwired interface to other components, including sensors 220, vehicle systems 350. Wired I/O interface 304 can communicate with other devices using Ethernet or any of a number of other wired communication protocols whether standardized, proprietary, open, point-to-point, networked or otherwise.

Power source 311 such as one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, another vehicle battery, alternator, etc.), an energy harvester (e.g., solar cells, piezoelectric system, etc.), or it can include any other suitable power supply. It is understood power source 311 can be coupled to a power source of the ego vehicle, such as a battery and alternator. Power source 311 can be used to power the platoon formation circuit 310.

Sensors 220 can include one or more of the previously mentioned sensors 220. Sensors 220 can include one or more sensors that may or not otherwise be included on a standard vehicle (e.g., vehicle 200) with which the platoon formation circuit 310 is implemented. In the illustrated example, sensors 220 include vehicle acceleration sensors 312, vehicle speed sensors 314, wheelspin sensors 316 (e.g., one for each wheel), a tire pressure monitoring system (TPMS) 320, accelerometers such as a 3-axis accelerometer 322 to detect roll, pitch and yaw of the vehicle, vehicle clearance sensors 324, left-right and front-rear slip ratio sensors 326, environmental sensors 328 (e.g., to detect weather, salinity or other environmental conditions), and camera(s) 213 (e.g. front rear, side, top, bottom facing). Additional sensors 219 can also be included as may be appropriate for a given implementation platoon formation system 300.

Vehicle systems 350 can include any of a number of different vehicle components or subsystems used to control or monitor various aspects of the ego vehicle and its performance. For example, it can include any or all of the aforementioned vehicle systems 230 and control systems 240 shown in FIG. 2. In this example, the vehicle systems 350 may include a GPS or other vehicle positioning system 218.

During operation, platoon formation circuit 310 can receive information from various vehicle sensors 220, vehicle systems 350, road conditions network 360, and high occupancy lane network 370 to identify vehicles and high occupancy lanes. Also, the driver, owner, and operator of the ego vehicle may manually trigger one or more processes described herein for evaluating road conditions of roads, driving patterns of vehicles, detecting high occupancy lanes of a road, and generating a platoon formation strategy to identify vehicles compatible to form a platoon. Communication circuit 301 can be used to transmit and receive information between the platoon formation circuit 310, sensors 220 and vehicle systems 350. Also, sensors 220 and platoon formation circuit 310 may communicate with vehicle systems 350 directly or indirectly (e.g., via communication circuit 301 or otherwise). Communication circuit 301 can be used to transmit and receive information between platoon formation circuit 310, one or more other systems of a vehicle 200, but also other elements of a road conditions network 360, such as vehicles, devices (e.g., mobile phones), systems, networks (such as a communications network and central server), and infrastructure, and elements of a high occupancy lane network 370.

In various applications, communication circuit 301 can be configured to receive data and other information from sensors 220 and vehicle systems 350 that is used in forming platoons of vehicles. As one example, when data is received from an element of road conditions network 360 (such as from a driver's user device), communication circuit 301 can be used to send an activation signal and activation information to one or more vehicle systems 350 or sensors 220 for the vehicle to detect and identify the high occupancy lanes and vehicles compatible for platooning. For example, it may be useful for vehicle systems 350 or sensors 220 to provide data useful in detecting and identifying high occupancy lanes and platoon compatible vehicles. Alternatively, platoon formation circuit 310 can be continuously receiving information from vehicle system 350, sensors 220, other vehicles, devices and infrastructure (e.g., those that are elements of road conditions network 360 and elements of high occupancy lane network 370). Further, upon identifying platooning compatible vehicles and high occupancy lanes of a road, communication circuit 301 can send a signal to other components of the vehicle, infrastructure, or other elements of the road conditions network and high occupancy lane network based on the identification of the high occupancy lanes. For example, the communication circuit 301 can send a signal to a vehicle system 350 that indicates a control input for performing one or more vehicle movement patterns to navigate around any obstructions on roads according to the determined road conditions, form platoons between compatible vehicles, and navigate on high occupancy lanes that are available for use. In some applications upon identifying platooning compatible vehicles and high occupancy lanes of a road, the driver's control of the vehicle can be prohibited, and control of the vehicle can be offloaded to the ADAS. In more specific examples, upon identifying platooning compatible vehicles and high occupancy lanes of a road (e.g., by sensors 220, and vehicle system 350, by elements of the road conditions network 360, or by elements of the high occupancy lane network 370), one or more signals can be sent to a vehicle system 350, so that an assist mode can be activated and the vehicle can control one or more of vehicle systems 230 (e.g., steering system 221, throttle system 222, brakes 223, transmission 224, ECU 225, propulsion system 226, suspension, and powertrain).

The examples of FIGS. 2 and 3 are provided for illustration purposes only as examples of vehicle 200 and platoon formation system 300 with which applications of the disclosed technology may be implemented. One of ordinary skill in the art reading this description will understand how the disclosed applications can be implemented with vehicle platforms.

FIG. 4 illustrates an example process 400 that includes one or more steps that may be performed to form a platoon of vehicles. In some applications, the process 400 can be executed, for example by the computing component 110 of FIG. 1. In another application, the process 400 may be implemented as the computing component 110 of FIG. 1. In other applications, the process 400 may be implemented as, for example, the computing system 210 of FIG. 2, the platoon formation system 300 of FIG. 3, the computing component 700 of FIG. 7, and the computing component 800 of FIG. 8. The process 400 may include a server. The process 400 may be implemented by one or more vehicles where the one or more vehicles may form a P2P or V2V network.

One or more vehicles, such as, for example, vehicles 420, 422, 424, and 426, may be traveling on a road. Each vehicle may include one or more sensors that may be used to collect data, including, for example, map data and sensor data, of the road that upon which the respective vehicle is traveling. The map data, which may be stored onboard a vehicle or obtained from the cloud or other infrastructure element, may include location, coordinates, population, landscape, landmark, terrain, territory, weather, temperature, humidity, pollution, habitat, and other environmental surroundings on, proximate to, and associated with the road that the vehicle is traveling on. The sensor data may include information on the condition of the road, damages to the road, hazardous features on the road, attributes of the road (i.e., the color, size, type and shape of lane markers, number of lanes, etc.), types of lanes (i.e., high occupancy lanes, merging lanes, exiting lanes, passing lanes, slow lanes, turning lanes, etc.), environmental conditions, lane markers and markings within the lane, map, location, traffic, speed, direction, and objects on, proximate to, and associated with the road that is collected by the respective vehicle. An object on the road may include a pothole, crack, tire marking, faded road marking, debris, occlusion, road reflection, flooding, ice, fire, oil leak, uneven pavement, erosion, raveling, sign, pole, building, structure, pedestrian, animal, and vehicle. The environmental conditions may include location, coordinates, population, landscape, landmark, terrain, territory, weather, temperature, humidity, pollution, habitat, and other environmental surroundings on, proximate to, or associated with the road upon which the respective vehicle is traveling. The computing component 110 may receive map data and sensor data of one or more vehicles.

Each vehicle 420, 422, 424, and 426 may collect map data of the road that each respective vehicle is traveling on. The map data, which may be stored onboard a vehicle or obtained from the cloud or other infrastructure element, may include location, coordinates, population, landscape, landmark, terrain, territory, weather, temperature, humidity, pollution, habitat, and other environmental surroundings on, proximate to, and associated with the road that the respective vehicle is traveling on. The map data, sensor data or both of a vehicle may be analyzed to determine a position of the respective vehicle on the road.

Each vehicle 420, 422, 424, and 426 may generate and send a platoon intent message, such as, platoon intent messages 430, to a platoon formation database 435. Each platoon intent message 430 may be a message presenting a vehicle's intention to seek to join a platoon of vehicles. The platoon intent message 430 of vehicle 420 may include a location of vehicle 420 (i.e., information associated with the precise position of vehicle 420 on the road it is traversing on), destination of vehicle 420 (i.e., information associated with the precise position of the destination that vehicle 420 is traveling to reach), high occupancy lane (HOL) price (i.e., a maximum, total dollar amount that vehicle 420 may be able or willing to spend to travel on a high occupancy lane), and driving preference of vehicle 420 (i.e., information associated with the preference of the driver of vehicle 420, including, for example, an average speed of travel, maximum speed of travel, maximum number of vehicles in a platoon, etc.). Each vehicle 420, 422, 424, and 426 may use one or more sensors to determine its respective location, destination, HOL price, and driving preference. Each vehicle 420, 422, 424, and 426 may use one or more forms of communication to send their respective platoon intent message 430 to the platoon formation database 435.

The computing component 110 may identify one or more vehicles that have a respective HOL price that is above a price threshold. The price threshold may be a minimum dollar value amount to be used for traveling on a HOL on the road. The price threshold may be a preset value. The price threshold may vary according to one or more factors, including, for example, time of day, day of week, destination of the vehicle 420, type of road the vehicle 420 is traveling on, current route of the vehicle 420, traffic on the road, road conditions, environmental conditions, etc. The price threshold may vary according to conditions and features of the road as determined from sensor data of one or more vehicles, including, for example, the vehicle 420. The price threshold may be updated according to algorithms and models using driving data of vehicles. Many variations are possible.

At step 402, the computing component 110 may determine whether there is a consensus between a plurality of vehicles in HOL pricing. Upon identifying one or more vehicles with a respective HOL price that is above a price threshold, the computing component 110 may determine if all such vehicles are in consensus with the HOL pricing. In one example, the one or more vehicles identified to have a respective HOL price that is above the price threshold are vehicles 420, 422, 424, and 426. To determine whether vehicles 420, 422, 424, and 426 are in consensus, the computing component 110 may receive dynamic HOL pricing 440 of the road that vehicles 420, 422, 424, and 426 are traveling on from an Application Programming Interface (API), network, or system. The dynamic HOL pricing 440 may provide HOL pricing of one or more HOLs on one or more roads. The HOL pricing of a HOL may be a monetary value that a vehicle may be charged when traveling on the HOL for a particular amount of time or distance or both. The computing component 110 may determine whether the respective HOL price of each vehicle 420, 422, 424, and 426 is above the HOL pricing of a HOL of the road the vehicles 420, 422, 424, and 426 are traveling on. The HOL price of a vehicle may be a maximum monetary value or budget that the respective vehicle may spend on fees to use a HOL. The HOL price of a vehicle may be a total monetary value that is available for use to pay for fees with using a HOL. Many variations are possible.

For example, vehicle 420 may have a HOL price of $10.00, vehicle 422 may have a HOL price $11.25, vehicle 424 may have a HOL price of $9.50, and vehicle 426 may have a HOL price of $10.75. The computing component 110 may determine that the HOL pricing of a HOL on the road being traveled on by vehicles 420, 422, 424, and 426 is $1.75. The computing component 110 may determine that the respective HOL price of each vehicle 420, 422, 424, and 426 is greater than or exceeds the HOL pricing $1.75 of the HOL, and may determine that each of the vehicles 420, 422, 424, and 426 are in consensus with the HOL pricing. Upon such a determination, the computing component 110 may determine that the vehicles 420, 422, 424, and 426 in consensus are compatible to form a platoon, and may proceed to step 404.

At step 404, the computing component 110 may determine if the vehicles in consensus to the HOL pricing are compatible for platoon formation. Upon a determination of vehicles 420, 422, 424, and 426 being in consensus with the HOL pricing, the computing component 110 may use information stored in the platoon formation database 435 determine if vehicles 420, 422, 424, and 426 are each at locations that are within a distance threshold from the location of a first vehicle, such as vehicle 420. The computing component 110 may determine if vehicles 420, 422, 424, and 426 are each at locations that are within a distance threshold from the location of vehicle 420 by analyzing the platoon intent message 430 of each vehicle 420, 422, 424, and 426. The distance threshold may be a maximum distance between the location of the vehicle 420 and the location of another vehicle. The distance threshold may be a preset value. The distance threshold may vary according to one or more factors, including, for example, time of day, day of week, location of the vehicle 420, type of road the vehicle 420 is traveling on, traffic on the road, road conditions, environmental conditions, etc. The distance threshold may vary according to conditions and features of the road as determined from sensor data of one or more vehicles, including, for example, the vehicle 420. The distance threshold may be updated according to algorithms and models using driving data of vehicles. Many variations are possible.

The computing component 110 may also determine if vehicles 420, 422, 424, and 426 each have a destination of travel that is within a destination threshold of the destination of the vehicle 420. The destination threshold may be a maximum distance between the destination of the vehicle 420 and the destination of another vehicle. The destination threshold may be a maximum distance between the destination of the vehicle 420 and the route of travel of the another vehicle to the destination of the another vehicle, and vice versa. Many variations are possible. The destination threshold may be a preset value. The destination threshold may vary according to one or more factors, including, for example, time of day, day of week, destination of the vehicle 420, type of road the vehicle 420 is traveling on, current route of the vehicle 420, traffic on the road, road conditions, environmental conditions, etc. The destination threshold may vary according to conditions and features of the road as determined from sensor data of one or more vehicles, including, for example, the vehicle 420. The destination threshold may be updated according to algorithms and models using driving data of vehicles. Many variations are possible.

Upon a determination that vehicles 420, 422, 424, and 426 each have a respective location and destination that are within the location threshold and destination threshold, the computing component 110 may determine that vehicles 420, 422, 424, and 426 are compatible for platoon formation. The computing component 110 may proceed to step 406 upon a determination that vehicles are compatible for platoon formation.

At step 406, the computing component 110 may generate future velocity profiles for each consensus vehicle. The computing component 110 may use information stored in the platoon formation database 435 to determine capabilities of each vehicle 420, 422, 424, and 426 that has been determined to be in consensus with HOL pricing and compatible for platoon formation. The capabilities of each vehicle 420, 422, 424, and 426 may be determined from the respective platoon intent message 430 of each vehicle 420, 422, 424, and 426. The platoon intent message 430 of a vehicle may include driving preference information of the respective vehicle. The driving preference of a vehicle may include information associated with the preference of the driver of the ego vehicle, including, for example, an average speed of travel, maximum speed of travel, maximum number of vehicles in a platoon, position in a platoon that the driver of the vehicle is comfortable with being at, etc. The driving preference of a vehicle may also include capabilities of the respective vehicle, including, for example, raw power, torque, acceleration, deceleration, steering, maximum steering angle, throttle response, vehicle braking, torque vectoring, handling, stability, aerodynamics, drivetrain, suspension system, etc.

According to the driving preference of each vehicle 420, 422, 424, and 426, the computing component 110 may generate future velocity profiles for each vehicle 420, 422, 424, and 426. The future velocity profiles for each vehicle 420, 422, 424, and 426 may include the capabilities and limitations of each vehicle, and each vehicle's abilities in forming a platoon. Upon generating future velocity profiles for each vehicle 420, 422, 424, and 426, the computing component 110 may proceed to step 408.

At step 408, the computing component 110 may generate a merging control strategy. The merging control strategy may include a set of instructions for vehicles 420, 422, 424, and 426 to execute to form a platoon. The computing component 110 may send the merging control strategy to each vehicle 420, 422, 424, and 426 to form a platoon. Each vehicle 420, 422, 424, and 426 may have its own set of instructions to execute to efficiently and effectively form a platoon. Each vehicle 420, 422, 424, and 426 may be assigned a particular position in the platoon, such as, for example, a lead position, following position, middle position, end position, first position, second position, third position, etc. The position assigned to each vehicle 420, 422, 424, and 426 in the formation of a platoon may be assigned at random by the computing component 110. The position assigned to each vehicle 420, 422, 424, and 426 in the formation of a platoon may be based on one or more factors, including, for example, future velocity profiles of each vehicle, driving preference of each vehicle, location of each vehicle, destination of each vehicle, HOL price of each vehicle, etc. The driving preference of a vehicle may include information associated with the preference of the driver of the vehicle, including, for example, an average speed of travel, maximum speed of travel, position in a platoon that the driver of the vehicle is comfortable with being at, etc.

Each vehicle 420, 422, 424, and 426 may have its own sensor data. The sensor data of each vehicle 420, 422, 424, and 426 may include a direction, speed, driving pattern, location, road condition, map, location, traffic, object, and environmental condition that the respective vehicle encountered during its travel on the road. Each vehicle 420, 422, 424, and 426 in the platoon may have one or more sensors capable of collecting data of the road and the driving performance of the respective vehicle. One or more sensors, either individually or in combination, may be able to collect data on the road, such as sensor data, to determine conditions and features of the road. The one or more sensors, either individually or in combination, may be able to collect data on the driving performance of the respective vehicle to determine the driving pattern of the respective vehicle on the road. The one or more sensors of a vehicle used to collect data may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS).

The computing component 110 may generate and send merging control strategy to each vehicle 420, 422, 424, and 426 to form a platoon. The merging control strategy may include instructions that may arrange vehicles 420, 422, 424, and 426 such that vehicle 420 is the lead vehicle, followed by vehicle 422 as the second vehicle, then vehicle 424 as the third vehicle, and lastly vehicle 426 as the rear vehicle in the platoon.

At step 410, the computing component 110 may implement a consensus platoon controller to determine whether there is a consensus between a plurality of vehicles in a platoon with a current HOL price of a HOL on the road. Upon the formation of a platoon with vehicles 420, 422, 424, and 426, the computing component 110 may send the vehicles 420, 422, 424, and 426 a platoon route for each vehicle 420, 422, 424, and 426 in the platoon to execute. The computing component 110 may generate the platoon route to include a route for each vehicle 420, 422, 424, and 426 in the platoon to follow to reach at least one destination of the vehicles 420, 422, 424, and 426 in the platoon. The platoon route may be generated according to one or more factors, including, for example, time of day, day of week, destination of one or more vehicles 420, 422, 424, and 426 in the platoon, type of road the platoon of vehicles 420, 422, 424, and 426 is traveling on, traffic on the road, road conditions, environmental conditions, and platooning optimization 460, that may include, for example, factors of safety 462, energy efficiency 464, road capacity 466, and comfort 468.

The platooning optimization 460 may include factors, conditions, and requirements that may be considered to efficiently, effectively, and safely establish and execute platooning of vehicles. The safety factor 462 may be associated with a minimum amount of safety conditions that the vehicles in a platoon may have to follow when traveling as a platoon, including, for example, a minimum distance of space between each vehicle in the platoon based on the speed of the platoon, maximum speed of travel allowed by each vehicle in the platoon, minimum distance of space between the lead vehicle of the platoon and the vehicle in front of the platoon, etc. The energy efficiency factor 464 may be associated with an amount of energy that each vehicle in the platoon may need to conserve when traveling in the platoon. The road capacity factor 466 may be associated with a number of vehicles on the road and near the location of the platoon of vehicles. The comfort factor 468 may be associated with driving preferences and capabilities of a vehicle, road conditions, environmental conditions, traffic, etc. Each factor of safety 462, energy efficiency 464, road capacity 466, and comfort 468 may be considered in generating the platoon route for the platoon of vehicles 420, 422, 424, and 426 to optimize in the formation and execution of platooning. To accomplish optimization in the formation and execution of platooning, the computing component 110 may also consider cost functions and predictive models in a model predictive control (MPC) 450. Cost functions and predictive models in the MPC 450 may be used in determining more accurate controls and actions to be executed on vehicles in a platoon to more efficiently, effectively, and safely form and execute platooning of vehicles. The computing component 110 may update the platoon route according to changes in the one or more factors. The platoon formation system may send the updated platoon route to each vehicle 420, 422, 424, and 426 in the platoon.

After a platoon of vehicles 420, 422, 424, and 426 is formed, the platoon of vehicles 420, 422, 424, and 426 may travel on the road according to the platoon route generated by the computing component 110. The computing component 110 may determine there is a HOL available on the road for the platoon to travel on. The HOL may be determined by the computing component 110 from sensor data of any of the vehicles 420, 422, 424, and 426 in the platoon. The computing component 110 may determine the presence of a HOL from sensor data of any vehicle on the road where the HOL is present. The computing component 110 may determine the presence of a HOL from GPS data of the road. Many variations are possible.

Once a HOL is determined to be available on the road the platoon is traveling on, the computing component 110 may determine whether each vehicle 420, 422, 424, and 426 in the platoon is in consensus to travel on the HOL. To determine whether each vehicle 420, 422, 424, and 426 in the platoon is in consensus, the computing component 110 may identify a current price of the HOL. The current price of the HOL may be a monetary value that a vehicle may be charged when traveling on the HOL for a particular amount of time or distance or both. The current price of the HOL may be determined by the computing component 110 from dynamic pricing HOL 440 received of the particular HOL identified on the road.

Using the current price of the HOL, the computing component 110 may determine the respective HOL price of each vehicle 420, 422, 424, and 426 in the platoon. The HOL price of a vehicle may be a maximum monetary value or budget that the vehicle may spend on fees to use a HOL. The HOL price of a vehicle may be a total monetary value that is available for use to pay for fees with using a HOL. Many variations are possible. For example, a platoon of vehicles 420, 422, 424, and 426 may include a HOL price of $10.00 for vehicle 420, a HOL price of $11.25 for vehicle 422, a HOL price of $9.50 for vehicle 424, and a HOL price of $10.75 for vehicle 426. The computing component 110 may compare the HOL price of each vehicle 420, 422, 424, and 426 in the platoon and proceed to step 412 to determine if the platoon of vehicles 420, 422, 424, and 426 may enter the HOL in their travel.

At step 412, the computing component 110 may determine if a platoon of vehicles may enter and use a HOL on a road. If the computing component 110 determines that the respective HOL price of each vehicle 420, 422, 424, and 426 in the platoon is greater than or exceeds the current price of the HOL, then the computing component 110 may proceed to update the platoon route to instruct the platoon of vehicles to travel on the HOL on the road. For example, if the current price of the HOL is $1.25 for each 2 miles of travel, and a platoon of four vehicles have respective HOL prices of $10.00, $11.25, $9.50, and $10.75, then each vehicle in the platoon is determined to have a respective HOL price that exceeds the current price of the HOL and the platoon formation system may determine that each vehicle in the platoon is in consensus with traveling on the HOL on the road.

If the computing component 110 determines that not all respective HOL prices of each vehicle 420, 422, 424, and 426 in the platoon are greater than or exceeds the current price of the HOL, then the computing component 110 may have the platoon of vehicles 420, 422, 424, and 426 continue to travel on the road using a regular lane, according to the current platoon route. The computing component 110 may also proceed to step 404 to reevaluate the platoon intent messages 430 of vehicles 420, 422, 424, and 426 and reestablish a new platoon formation of vehicles that may enter a HOL in its travel. Many variations are possible As a vehicle travels on a HOL, the vehicle's HOL price may decrease according to costs incurred from traveling on the HOL. When a vehicle's HOL price decreases to a value that is less than a current price of a HOL, the computing component 110 may determine that the respective vehicle is not in consensus to travel on the HOL. When at least one vehicle in a platoon is not in consensus with traveling on the HOL on a road, the computing component 110 may generate a platoon route for the platoon to travel on the road using a regular lane and not a HOL. When at least one vehicle in a platoon is in consensus to travel on a HOL and at least one vehicle in the platoon is not in consensus to travel on the HOL, the computing component 110 may provide instructions to the vehicles in the platoon to disengage from the platoon formation. This may cause each vehicle to be independent from one another and no longer receive and execute instructions of travel from the computing component 110. When at least two vehicles in a platoon is in consensus to travel on a HOL and at least one vehicle in the platoon is not in consensus to travel on the HOL, the computing component 110 may provide instructions to the vehicles not in consensus to disengage from the platoon formation. This may cause the vehicles not in consensus to be independent from the other vehicles remaining in the platoon and to no longer receive and execute instructions of travel from the computing component 110. Many variations are possible.

A vehicle in a platoon may disengage from the platoon for a variety of reasons, including, for example, when the vehicle is not in consensus with traveling on a HOL while other vehicles in the platoon are in consensus, when the vehicle reaches a point in the platoon route where it needs to disengage and separate itself to reach its respective destination, when the vehicle has to make a stop (e.g., to refill gas, recharge vehicle battery, purchase food, use restroom, take rest stop, fix vehicle, buy medicine, etc.), and when the driver of the vehicle chooses to no longer be in the platoon. A vehicle in a platoon may disengage from the platoon by sending a platoon disengage message to the platoon formation database 435. The computing component 110 may disengage a vehicle from a platoon by sending instructions to the vehicle for disengaging from the platoon. The computing component 110 may disengage a vehicle from a platoon without first receiving a platoon disengage message, when the computing component 110 determines that the vehicle needs to be disengaged from the platoon based on the platoon intent message of the vehicle. Many variations are possible.

When a vehicle in a platoon is determined to be disengaged from the platoon, the computing component 110 may send instructions to the disengaging vehicle to disengage from the platoon formation. The computing component 110 may generate an updated merging control strategy for each remaining vehicle in the platoon and send the updated merging control strategy to each remaining vehicle. Each remaining vehicle may execute the updated merging control strategy to establish an updated platoon formation upon the separation of the disengaged vehicle. In one example, if vehicle 424 in a four vehicle platoon of vehicles 420, 422, 424, and 426 is determined to disengage from the platoon, an updated merging control strategy may be provided to have the remaining vehicles 420, 422, and 426 establish an updated platoon formation where the vehicle 426 will now move closer to the vehicle 422 and take the place of the disengaged vehicle 424. The updated platoon formation may now consist of only the remaining three vehicles 420, 422, and 426, with vehicle 420 being the lead vehicle, vehicle 422 being the middle vehicle, and vehicle 426 being the rear vehicle in the platoon. In another example, if vehicle 420 in a four vehicle platoon of vehicles 420, 422, 424, and 426 is determined to disengage from the platoon, an updated merging control strategy may be provided to have the remaining vehicles 422, 424, and 426 establish an updated platoon formation where vehicle 422 becomes the lead vehicle of the platoon and takes the place of the disengaged vehicle 420. The updated platoon formation may now consist of only the remaining three vehicles 422, 424, and 426, with vehicle 422 being the lead vehicle, vehicle 424 being the middle vehicle, and vehicle 426 being the rear vehicle in the platoon. Once the remaining vehicles have established the updated platoon formation, the updated platoon may continue traveling on the road according to the platoon route provided by the computing component 110.

Each of the vehicles 420, 422, 424, and 426 in a platoon may communicate to one another and to the platoon formation system using a P2P (peer-to-peer), V2V or other communication protocol. A platoon of vehicles may move together according to a navigation strategy (i.e., a platoon route) to travel efficiently, effectively, and safely navigate the platoon of vehicles on a road.

Monitoring data of various vehicles traveling on a road may permit up-to-date navigation information and road conditions, that may be analyzed to efficiently and accurately identify compatible vehicles for platoon formation and navigate a platoon of vehicles on a road. The efficient and accurate determination of compatible vehicles may improve the efficiency, effectiveness, and safety of forming platoons of vehicles and in the navigation of platoons of vehicles traveling on the road. Efficiently, effectively, and safely controlling platooning may further increase the avoidance of incidents and accidents occurring on the road.

For simplicity of description, the process 400 is described as being performed with respect to a single platoon. It should be appreciated that, in a typical embodiment, the computing component 110 may manage the determination of vehicles compatible and in consensus to form a plurality of platoons, at various locations, on various roads, in short succession of one another. For example, in some embodiments, the computing component 110 can perform many, if not all, of the steps in process 400 on a plurality of vehicles for a plurality of platoons on various roads as data is obtained from a plurality of vehicles.

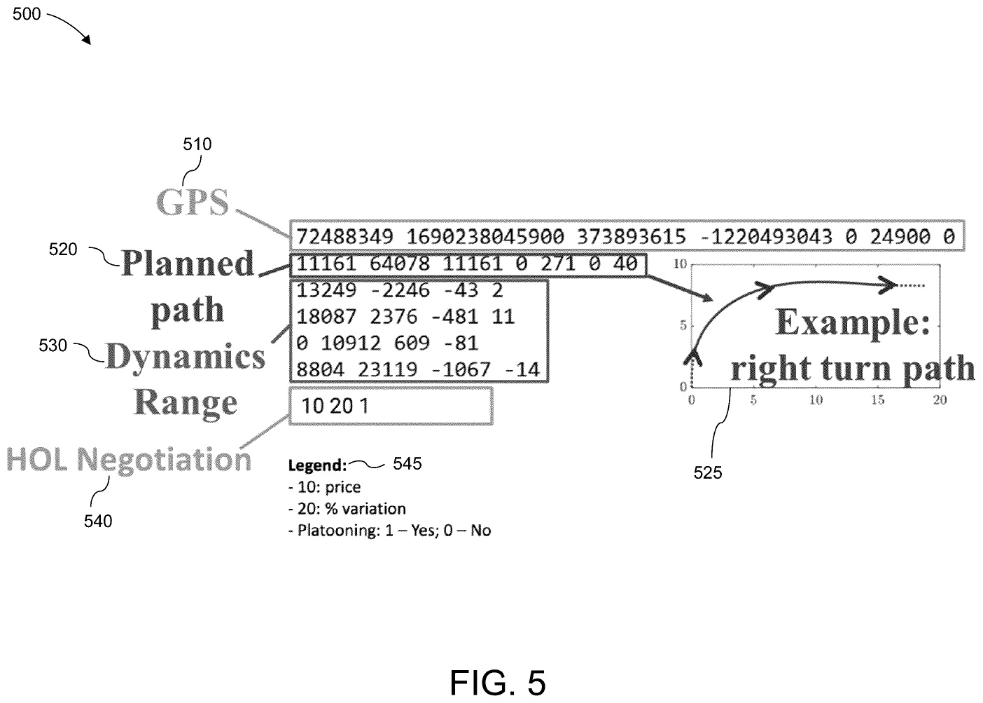

FIG. 5 illustrates an example platoon intent message 500 for platoon formation. The platoon intent message 500 may be a message presenting an ego vehicle's (such as, for example, vehicle 150 and vehicle 200) intention to seek to join a platoon of vehicles. The platoon intent message 500 of the ego vehicle may include information and data of GPS 510, planned path 520, navigational directions, such as direction 525, dynamics range 530, and HOL pricing negotiation 540. The information and data of GPS 510, planned path 520, navigational directions 525, dynamics range 530, and HOL pricing negotiation 540 may be displayed in numeric code. The information and data of GPS 510, planned path 520, navigational directions 525, dynamics range 530, and HOL pricing negotiation 540 may be used to determine the location, direction, destination, travel path, capabilities, and high occupancy lane (HOL) pricing of the ego vehicle.

The GPS 510 data of the platoon intent message 500 of the ego vehicle may be used to determine the location of the ego vehicle, which may include information associated with the precise position of the ego vehicle on the road it is traversing on. The planned path 520 data of the platoon intent message 500 of the ego vehicle may be used to determine the destination of the ego vehicle, which may include information associated with the precise position of the destination that the ego vehicle is traveling to reach. The dynamics range 530 of the platoon intent message 500 of the ego vehicle may be used to determine the driving preference of the ego vehicle, which may include information associated with the preference of the driver of the ego vehicle, including, for example, an average speed of travel, maximum speed of travel, maximum number of vehicles in a platoon, etc. The HOL pricing negotiation 540 of the platoon intent message 500 of the ego vehicle may be used to determine the HOL price of the ego vehicle, which may include information of a maximum, total dollar amount that the ego vehicle may be able or willing to spend to travel on a high occupancy lane. The information and data of the HOL pricing negotiation 540 may include a numeric value to represent a price to be spent traveling on a HOL, a numeric value to represent a percentage of variation from the price, and a numeric value representing whether the ego vehicle may be able to travel on a HOL with the price and percentage variation values when traveling in a platoon of vehicles. For example, as shown in FIG. 5, the numeric value of “10” may represent a price of $10.00 that the ego vehicle is willing to pay to travel on a HOL, the numeric value of “20” may represent a 20% of variation from the price that the ego vehicle is willing to adjust its amount to pay to travel on a HOL, and “1” may represent that the ego vehicle agrees to travel on a HOL when traveling in a platoon, while “0” may represent that the ego vehicle does not agree to travel on a HOL when traveling in a platoon. The ego vehicle may use one or more sensors to determine the information and data to be inputted for GPS 510, planned path 520, navigational directions 525, dynamics range 530, and HOL pricing negotiation 540. The ego vehicle may use one or more forms of communication to send the platoon intent message 500 to a platoon formation system.

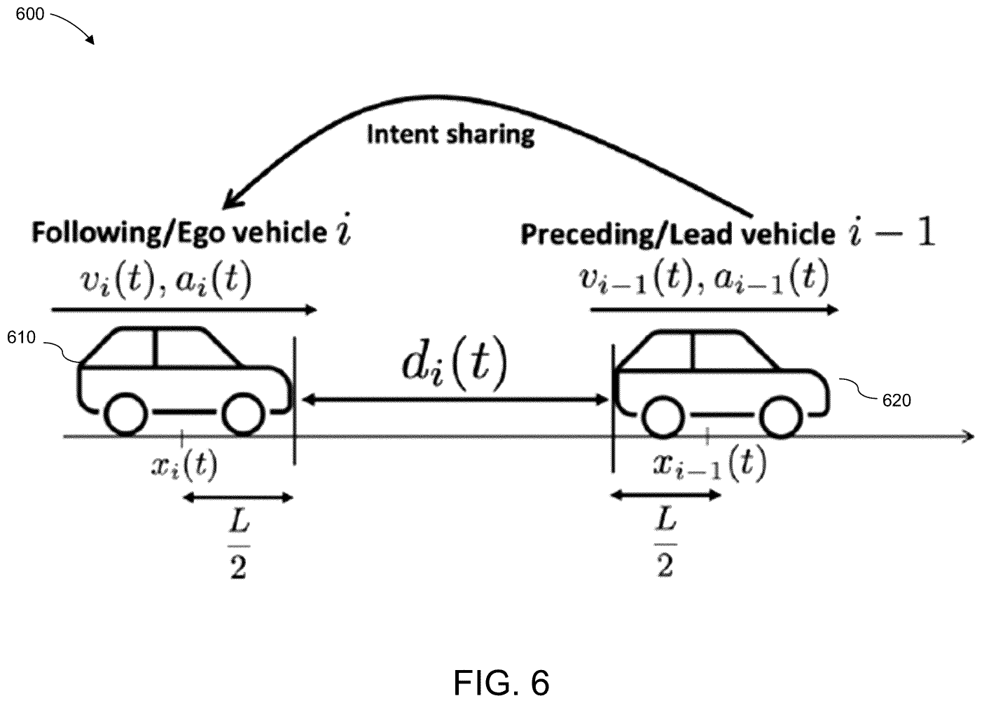

FIG. 6 illustrates an example diagram 600 that includes variables and factors used for intent sharing for platooning between vehicles. Vehicles in a platoon, such as vehicles 610 and 620, may perform intent sharing by P2P (peer-to-peer), V2V (vehicle-to-vehicle), V2X (vehicle-to-everything), or other communication protocols. Vehicles 610 and 620 in a platoon may exchange their anticipated future trajectories to each other using information of position, speed, and time.

To model intent-sharing for platooning between vehicles, such as vehicles 610 and 620, we can consider, at any given time, t, the lead vehicle 620 to be i−1 and the following vehicle 610 to be i. The lead vehicle 620 may determine its anticipated future trajectory, including future positions xᵢ₋₁(t)=[xᵢ₋₁(τ)]^{t+N}, future velocities vᵢ₋₁(t)=[t+N]^{τ=t}[t+N]^{[vi-1(τ)]}_{τ=t}, and future accelerations aᵢ₋₁(t)=[aᵢ₋₁(τ)]_{T=N}. N may be a tuning parameter that represents the intent horizon. The large value of N may require more communication resources, since it may encompass more information about the future trajectory of the lead vehicle 620. Then the following vehicle 610 may receive and utilize the anticipated future trajectory of the lead vehicle 620 to determine its own future velocities vᵢ(t), future accelerations aᵢ(t), and future positions xᵢ(t) to maintain a steady distance dᵢ(t) between the vehicles 610 and 620. In this way, vehicles in a platoon may perform platooning in a safe and efficient manner where the vehicles are able to properly follow each other at consistent speeds while maintaining adequate distances between each other to increase the avoidance of incidents and accidents occurring on the road.

FIG. 7 illustrates an example computing component 700 that includes one or more hardware processors 702 and machine-readable storage media 704 storing a set of machine-readable/machine-executable instructions that, when executed, cause the hardware processor(s) 702 to perform an illustrative method of platoon formation. It should be appreciated that there can be additional, fewer, or alternative steps performed in similar or alternative orders, or in parallel, within the scope of the various examples discussed herein unless otherwise stated. The computing component 700 may be implemented as the computing component 110 of FIG. 1, the computing system 210 of FIG. 2, the platoon formation system 300 of FIG. 3, the process 400 of FIG. 4, and the computing component 800 of FIG. 8.

At step 706, the hardware processor(s) 702 may execute machine-readable/machine-executable instructions stored in the machine-readable storage media 704 to receive a platoon intent message from a vehicle. An ego vehicle may be traveling on a road. The ego vehicle may collect sensor data of the road upon which the ego vehicle is traveling. The ego vehicle may include, for example, an automobile, truck, motorcycle, bicycle, scooter, moped, recreational vehicle and other like on- or off-road vehicles. The ego vehicle may include, for example, an autonomous, semi-autonomous and manual operation.

The ego vehicle may include one or more sensors that may be used to collect sensor data and map data of the road. The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). Data may be received from at least one sensor of the ego vehicle. The sensor data may include information on the condition of the road, damages to the road, hazardous features on the road, attributes of the road (i.e., the color, size, type and shape of lane markers, number of lanes, etc.), types of lanes (i.e., high occupancy lanes, merging lanes, exiting lanes, passing lanes, slow lanes, turning lanes, etc.), environmental conditions, lane markers and markings within the lane, map, location, traffic, speed, direction, and objects on, proximate to, and associated with the road that is collected by the ego vehicle. An object on the road may include a pothole, crack, tire marking, faded road marking, debris, occlusion, road reflection, flooding, ice, fire, oil leak, uneven pavement, erosion, raveling, sign, pole, building, structure, pedestrian, animal, and vehicle. The environmental condition may include location, coordinates, population, landscape, landmark, terrain, territory, weather, temperature, humidity, pollution, habitat, and other environmental surroundings on, proximate to, or associated with the road that the ego vehicle is traveling on.

The ego vehicle may collect map data of the road that the ego vehicle is traveling on. The map data, which may be stored onboard the vehicle or obtained from the cloud or other infrastructure element, may include location, coordinates, population, landscape, landmark, terrain, territory, weather, temperature, humidity, pollution, habitat, and other environmental surroundings on, proximate to, and associated with the road that the ego vehicle is traveling on. The map data, sensor data or both may be analyzed to determine a position of the ego vehicle on the road.

The ego vehicle may generate and send a platoon intent message to a platoon formation system. The platoon intent message may be a message presenting the ego vehicle's intention to seek to join a platoon of vehicles. The platoon intent message of the ego vehicle may include a location of the ego vehicle (i.e., information associated with the precise position of the ego vehicle on the road it is traversing on), destination of the ego vehicle (i.e., information associated with the precise position of the destination that the ego vehicle is traveling to reach), high occupancy lane (HOL) price (i.e., a maximum, total dollar amount that the ego vehicle may be able or willing to spend to travel on a high occupancy lane), and driving preference of the ego vehicle (i.e., information associated with the preference of the driver of the ego vehicle, including, for example, an average speed of travel, maximum speed of travel, maximum number of vehicles in a platoon, etc.). The ego vehicle may use one or more sensors to determine its location, destination, HOL price, and driving preference. The ego vehicle may use one or more forms of communication to send the platoon intent message to the platoon formation system.

At step 708, the hardware processor(s) 702 may execute machine-readable/machine-executable instructions stored in the machine-readable storage media 704 to determine a location, destination, and high occupancy lane (HOL) price of the first vehicle from the platoon intent message. Upon receiving the platoon intent message from the ego vehicle, the platoon formation system may determine the location, destination, and HOL price of the ego vehicle. The location of the ego vehicle may include information associated with the precise position of the ego vehicle on the road it is traversing on. The location of the ego vehicle may be determined according to a GPS of the ego vehicle. The destination of the ego vehicle may include information associated with the precise position of the destination that the ego vehicle is traveling to reach as its final destination. The destination of the ego vehicle may be determined according to a GPS of the ego vehicle. The high occupancy lane (HOL) price may include information associated with a maximum, total dollar amount that the ego vehicle may be able or willing to spend to travel on a high occupancy lane while traveling in a platoon of vehicles.

At step 710, the hardware processor(s) 702 may execute machine-readable/machine-executable instructions stored in the machine-readable storage media 704 to identify a second vehicle based on a second platoon intent message indicating a location and destination of the second vehicle that are within a location threshold and destination threshold of the location and destination of the vehicle. One or more vehicles may send a respective platoon intent message to the platoon formation system, presenting each vehicle's intention to join a platoon of vehicles. Each platoon intent message of a vehicle may include a location, destination, HOL price, and driving preference of the respective vehicle.

After receiving the platoon intent message of the ego vehicle, the platoon formation system may identify one or more vehicles at one or more locations within a distance threshold from the location of the ego vehicle. The platoon formation system may identify such one or more vehicles at one or more locations within a distance threshold from the location of the ego vehicle by analyzing the platoon intent message of each of the one or more vehicles. The distance threshold may be a maximum distance between the location of the ego vehicle and the location of another vehicle. The distance threshold may be a preset value. The distance threshold may vary according to one or more factors, including, for example, time of day, day of week, location of the ego vehicle, type of road the ego vehicle is traveling on, traffic on the road, road conditions, environmental conditions, etc. The distance threshold may vary according to conditions and features of the road as determined from sensor data of one or more vehicles, including, for example, the ego vehicle and the second vehicle. The distance threshold may be updated according to algorithms and models using driving data of vehicles. Many variations are possible.

After determining a set of one or more vehicles at one or more locations within the distance threshold away from the location of the ego vehicle, the platoon formation system may determine which vehicles of the set of one or more vehicles has a destination of travel that is within a destination threshold of the destination of the ego vehicle. The destination threshold may be a maximum distance between the destination of the ego vehicle and the destination of another vehicle. The destination threshold may be a maximum distance between the destination of the ego vehicle and the route of travel of the another vehicle to the destination of the another vehicle, and vice versa. Many variations are possible. The destination threshold may be a preset value. The destination threshold may vary according to one or more factors, including, for example, time of day, day of week, destination of the ego vehicle, type of road the ego vehicle is traveling on, route of the ego vehicle, traffic on the road, road conditions, environmental conditions, etc. The destination threshold may vary according to conditions and features of the road as determined from sensor data of one or more vehicles, including, for example, the ego vehicle and the second vehicle. The destination threshold may be updated according to algorithms and models using driving data of vehicles. Many variations are possible.

At step 712, the hardware processor(s) 702 may execute machine-readable/machine-executable instructions stored in the machine-readable storage media 704 to determine a second HOL price of the second vehicle based on the second platoon intent message. Amongst the subset of one or more vehicles that are determined to be within the location threshold and destination threshold from the ego vehicle, the platoon formation system may determine a respective HOL price of each of the subset of one or more vehicles. The platoon formation system may determine the respective HOL price of each of the subset of one or more vehicles from each vehicle's respective platoon intent message.

At step 714, the hardware processor(s) 702 may execute machine-readable/machine-executable instructions stored in the machine-readable storage media 704 to establish a platoon between the vehicle and the second vehicle, upon a determination that the HOL price of the vehicle and the second HOL price of the second vehicle are above a price threshold. After determining the respective HOL price of each of the subset of one or more vehicles that are determined to be within the location threshold and destination threshold from the ego vehicle, the platoon formation system may identify one or more vehicles that have a respective HOL price that is above a price threshold. The price threshold may be a minimum dollar value amount to be used for traveling on a HOL on the road. The price threshold may be a preset value. The price threshold may vary according to one or more factors, including, for example, time of day, day of week, destination of the ego vehicle, type of road the ego vehicle is traveling on, route of the ego vehicle, traffic on the road, road conditions, environmental conditions, etc. The price threshold may vary according to conditions and features of the road as determined from sensor data of one or more vehicles, including, for example, the ego vehicle and the second vehicle. The price threshold may be updated according to algorithms and models using driving data of vehicles. Many variations are possible.

The one or more vehicles from the subset of vehicles determined to have a respective HOL price that is above the price threshold may be instructed to form a platoon with the ego vehicle by the platoon formation system. To establish a platoon between the ego vehicle and one or more vehicles, the platoon formation system may generate platoon formation strategy. The platoon formation strategy may include instructions for each vehicle to execute to establish a platoon. The platoon formation system may send the platoon formation strategy to each vehicle involved in forming a platoon. Each vehicle determined to form a platoon may execute instructions from the platoon formation strategy to establish the platoon. Each vehicle may have its own set of instructions to execute to efficiently and effectively form the platoon. Each vehicle may be assigned a particular position in the platoon, such as, for example, a lead position, following position, middle position, end position, first position, second position, third position, etc. The position assigned to each vehicle determined to form a platoon may be assigned at random by the platoon formation system. The position assigned to each vehicle determined to form a platoon may be based on one or more factors, including, for example, driving preference of each vehicle, location of each vehicle, destination of each vehicle, HOL price of each vehicle, etc. The driving preference of a vehicle may include information associated with the preference of the driver of the vehicle, including, for example, an average speed of travel, maximum speed of travel, position in a platoon that the driver of the vehicle is comfortable with being at, etc.

Each vehicle may have its own sensor data. The sensor data of each vehicle may include a direction, speed, driving pattern, location, road condition, map, location, traffic, object, and environmental condition that the respective vehicle encountered during its travel on the road. Each vehicle in the platoon may have one or more sensors capable of collecting data of the road and the driving performance of the respective vehicle. One or more sensors, either individually or in combination, may be able to collect data on the road, such as sensor data, to determine conditions and features of the road. The one or more sensors, either individually or in combination, may be able to collect data on the driving performance of the respective vehicle to determine the driving pattern of the respective vehicle on the road. The one or more sensors of the vehicle used to collect data may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS).

Upon the ego vehicle and one or more other vehicles forming a platoon, the platoon formation system may send the vehicles a platoon route for each vehicle in the platoon to execute. The platoon formation system may generate the platoon route to include a route for each vehicle in the platoon to follow to reach at least one destination of the vehicles in the platoon. The platoon route may be generated according to one or more factors, including, for example, time of day, day of week, destination of one or more vehicles in the platoon, type of road the platoon of vehicles is traveling on, traffic on the road, road conditions, environmental conditions, safety, energy efficiency, road capacity, comfort, etc. The safety factor may be associated with a minimum amount of safety conditions that the vehicles in a platoon may have to follow when traveling as a platoon, including, for example, a minimum distance of space between each vehicle in the platoon based on the speed of the platoon, maximum speed of travel allowed by each vehicle in the platoon, minimum distance of space between the lead vehicle of the platoon and the vehicle in front of the platoon, etc. The energy efficiency factor may be associated with an amount of energy that each vehicle in the platoon may need to conserve when traveling in the platoon. The road capacity factor may be associated with a number of vehicles on the road and near the location of the platoon of vehicles. The comfort factor may be associated with at least one of driving preferences of each driver of each vehicle in the platoon, capabilities of each vehicle in the platoon, road conditions, environmental conditions, traffic, etc. Each factor considered in generating the platoon route may be based on capabilities of each vehicle in the platoon, the location of the platoon of vehicles, characteristics of the road, environmental conditions, etc. The platoon formation system may update the platoon route according to changes in the one or more factors. The platoon formation system may send the updated platoon route to each vehicle in the platoon.

After a platoon of vehicles is formed, the platoon of vehicles may travel on the road according to the platoon route generated by the platoon formation system. The platoon formation system may determine there is a HOL available on the road for the platoon to travel on. The HOL may be determined by the platoon formation system from sensor data of any of the vehicles in the platoon. The platoon formation system may determine the presence of a HOL from sensor data of any vehicle on the road where the HOL is present. The platoon formation system may determine the presence of a HOL from GPS data of the road. Many variations are possible.

Once a HOL is determined to be available on the road the platoon is traveling on, the platoon formation system may determine whether each vehicle in the platoon is in consensus to travel on the HOL. To determine whether each vehicle in the platoon is in consensus, the platoon formation system may identify a current price of the HOL. The current price of the HOL may be a monetary value that a vehicle may be charged when traveling on the HOL for a particular amount of time or distance or both. Using the current price of the HOL, the platoon formation system may determine the respective HOL price of each vehicle in the platoon. The HOL price of a vehicle may be a maximum monetary value or budget that the vehicle may spend on fees to use a HOL. The HOL price of a vehicle may be a total monetary value that is available for use to pay for fees with using a HOL. Many variations are possible. For example, a platoon of four vehicles may have a first vehicle with a HOL price of $10.00, a second vehicle with a HOL price $11.25, a third vehicle with a HOL price of $9.50, and a fourth vehicle with a HOL price of $10.75. If the platoon formation system determines that the respective HOL price of each vehicle in the platoon is greater than or exceeds the current price of the HOL, then the platoon formation system may update the platoon route to instruct the platoon of vehicles to travel on the HOL on the road. For example, if the current price of the HOL is $1.25 for each 2 miles of travel, and a platoon of four vehicles have respective HOL prices of $10.00, $11.25, $9.50, and $10.75, then each vehicle in the platoon is determined to have a respective HOL price that exceeds the current price of the HOL and the platoon formation system may determine that each vehicle in the platoon is in consensus with traveling on the HOL on the road.

As a vehicle travels on a HOL, the vehicle's HOL price may decrease according to costs incurred from traveling on the HOL. When a vehicle's HOL price decreases to a value that is less than a current price of a HOL, the platoon formation system may determine that the vehicle is not in consensus to travel on the HOL. When at least one vehicle in a platoon is not in consensus with traveling on the HOL on a road, the platoon formation system may generate a platoon route for the platoon to travel on the road using a regular lane and not a HOL. When at least one vehicle in a platoon is in consensus to travel on a HOL and at least one vehicle in the platoon is not in consensus to travel on the HOL, the platoon formation system may provide instructions to the vehicles in the platoon to disengage from the platoon formation. This may cause each vehicle to be independent from one another and no longer receive and execute instructions of travel from the platoon formation system. When at least two vehicles in a platoon is in consensus to travel on a HOL and at least one vehicle in the platoon is not in consensus to travel on the HOL, the platoon formation system may provide instructions to the vehicles not in consensus to disengage from the platoon formation. This may cause the vehicles not in consensus to be independent from the other vehicles remaining in the platoon and to no longer receive and execute instructions of travel from the platoon formation system. Many variations are possible.

A vehicle in a platoon may disengage from the platoon for a variety of reasons, including, for example, when the vehicle is not in consensus with traveling on a HOL while other vehicles in the platoon are in consensus, when the vehicle reaches a point in the platoon route where it needs to disengage and separate itself to reach its respective destination, when the vehicle has to make a stop (e.g., to refill gas, recharge vehicle battery, purchase food, use restroom, take rest stop, fix vehicle, buy medicine, etc.), and when the driver of the vehicle chooses to no longer be in the platoon. A vehicle in a platoon may disengage from the platoon by sending a platoon disengage message to the platoon formation system. The platoon formation system may disengage a vehicle from a platoon by sending instructions to the vehicle for disengaging from the platoon. The platoon formation system may disengage a vehicle from a platoon without first receiving a platoon disengage message, when the platoon formation system determines that the vehicle needs to be disengaged from the platoon based on the platoon intent message of the vehicle. Many variations are possible.

When a vehicle in a platoon is determined to be disengaged from the platoon, the platoon formation system may send instructions to the disengaging vehicle to disengage from the platoon formation. The platoon formation system may generate an updated platoon formation strategy for each remaining vehicle in the platoon and send the updated platoon formation strategy to each remaining vehicle. Each remaining vehicle may execute the updated platoon formation strategy to establish an updated platoon formation upon the separation of the disengaged vehicle. In one example, if the third vehicle in a four vehicle platoon is determined to disengage from the platoon, an updated platoon formation strategy may be provided to have the remaining vehicles establish an updated platoon formation where the fourth vehicle will now move closer to the second vehicle and take the place of the disengaged third vehicle. The updated platoon formation may now consist of only the remaining three vehicles. In another example, if the first vehicle in a four vehicle platoon is determined to disengage from the platoon, an updated platoon formation strategy may be provided to have the remaining vehicles establish an updated platoon formation where the second vehicle becomes the lead vehicle of the platoon and takes the place of the disengaged first vehicle. The updated platoon formation may now consist of only the remaining three vehicles. Once the remaining vehicles have established the updated platoon formation, the updated platoon may continue traveling on the road according to the platoon route provided by the platoon formation system.

Each of the vehicles in a platoon may communicate to one another and to the platoon formation system using a P2P (peer-to-peer), V2V or other communication protocol. A platoon of vehicles may move together according to a navigation strategy (i.e., a platoon route) to travel efficiently, effectively, and safely navigate the platoon of vehicles on a road.

Monitoring data of various vehicles traveling on a road may permit up-to-date navigation information and road conditions, that may be analyzed to efficiently and accurately identify compatible vehicles for platoon formation and navigate a platoon of vehicles on a road. The efficient and accurate determination of compatible vehicles may improve the efficiency, effectiveness, and safety of forming platoons of vehicles and in the navigation of platoons of vehicles traveling on the road. Efficiently, effectively, and safely controlling platooning may further increase the avoidance of incidents and accidents occurring on the road.

As used herein, the terms circuit, system, and component might describe a given unit of functionality that can be performed in accordance with one or more applications of the present application. As used herein, a component might be implemented utilizing any form of hardware, software, or a combination thereof. For example, one or more processors, controllers, ASICS, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software (such as user device applications described herein), these software elements can be implemented to operate with a computing or processing component capable of carrying out the functionality described with respect thereto. One such example computing component is shown in FIG. 8. Various applications are described in terms of this example-computing component 800. After reading this description, it will become apparent to a person skilled in the relevant art how to implement the application using other computing components or architectures.

Referring now to FIG. 8, computing component 800 may represent, for example, computing or processing capabilities found within a vehicle (e.g., vehicle 150, vehicle 200), user device, self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 800 might also represent computing capabilities embedded within or otherwise available to a given device. For example, a computing component might be found in other electronic devices such as, for example, portable computing devices, and other electronic devices that might include some form of processing capability. In another example, a computing component might be found in components making up vehicle 150, vehicle 200, platoon formation circuit 310, decision and control circuit 303, computing system 100, computing system 210, ECU 225, etc.

Computing component 800 might include, for example, one or more processors, controllers, control components, or other processing devices. This can include a processor, and any one or more of the components making up vehicle 150 of FIG. 1, vehicle 200 of FIG. 2, computing system 210 of FIG. 2, and platoon formation system 300 of FIG. 3. Processor 804 might be implemented using a general-purpose or special-purpose processing engine such as, for example, a microprocessor, controller, or other control logic. The processor 804 might be specifically configured to execute one or more instructions for execution of logic of one or more circuits described herein, such as platoon formation circuit 310, decision and control circuit 303, and logic for control systems 240. Processor 804 may be configured to execute one or more instructions for performing one or more methods, such as the process described in FIG. 4 and the method described in FIG. 7.

Processor 804 may be connected to a bus 802. However, any communication medium can be used to facilitate interaction with other components of computing component 800 or to communicate externally. In applications, processor 804 may fetch, decode, and execute one or more instructions to control processes and operations for enabling vehicle servicing as described herein. For example, instructions can correspond to steps for performing one or more steps of the process described in FIG. 4 and the method described in FIG. 7.

Computing component 800 might also include one or more memory components, simply referred to herein as main memory 808. For example, random access memory (RAM) or other dynamic memory, might be used for storing information and instructions to be fetched, decoded, and executed by processor 804. Such instructions may include one or more instructions for execution of one or more logical circuits described herein. Instructions can include instructions 208 of FIG. 2, and instructions 309 of FIG. 3 as described herein, for example. Main memory 808 might also be used for storing temporary variables or other intermediate information during execution of instructions to be fetched, decoded, and executed by processor 804. Computing component 800 might likewise include a read only memory (“ROM”) or other static storage device coupled to bus 802 for storing static information and instructions for processor 804.

The computing component 800 might also include one or more various forms of information storage mechanism 810, which might include, for example, a media drive 812 and a storage unit interface 820. The media drive 812 might include a drive or other mechanism to support fixed or removable storage media 814. For example, a hard disk drive, a solid-state drive, a magnetic tape drive, an optical drive, a compact disc (CD) or digital video disc (DVD) drive (R or RW), or other removable or fixed media drive might be provided. Storage media 814 might include, for example, a hard disk, an integrated circuit assembly, magnetic tape, cartridge, optical disk, a CD or DVD. Storage media 814 may be any other fixed or removable medium that is read by, written to or accessed by media drive 812. As these examples illustrate, the storage media 814 can include a computer usable storage medium having stored therein computer software or data.

In alternative applications, information storage mechanism 810 might include other similar instrumentalities for allowing computer programs or other instructions or data to be loaded into computing component 800. Such instrumentalities might include, for example, a fixed or removable storage unit 822 and an interface 820. Examples of such storage unit 822 and interface 820 can include a program cartridge and cartridge interface, a removable memory (for example, a flash memory or other removable memory component) and memory slot. Other examples may include a PCMCIA slot and card, and other fixed or removable storage units 822 and interfaces 820 that allow software and data to be transferred from storage unit 822 to computing component 800.

Computing component 800 might also include a communications interface 824. Communications interface 824 might be used to allow software and data to be transferred between computing component 800 and external devices. Examples of communications interface 824 might include a modem or softmodem, a network interface (such as Ethernet, network interface card, IEEE 802.XX or other interface). Other examples include a communication port (such as for example, a USB port, IR port, RS232 port Bluetooth® interface, or other port), or other communications interface. Software/data transferred via communications interface 824 may be carried on signals, which can be electronic, electromagnetic (which includes optical) or other signals capable of being exchanged by a given communications interface 824. These signals might be provided to communications interface 824 via a channel 828. Channel 828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 808, storage unit 822, media 814, and channel 828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 800 to perform features or functions of the present application as discussed herein.

As described herein, vehicles can be flying, partially submersible, submersible, boats, roadway, off-road, passenger, truck, trolley, train, drones, motorcycle, bicycle, or other vehicles. As used herein, vehicles can be any form of powered or unpowered transport. Obstructions can include one or more potholes, cracks, tire markings, faded road markings, debris, objects, occlusion, road reflection, floodings, icy surfaces, oil leaks, uneven pavement, erosions, raveling and other potentially hazardous conditions on the road. Although roads are references herein, it is understood that the present disclosure is not limited to roads or to 1d or 2d traffic patterns.

The term “operably connected,” “coupled”, or “coupled to”, as used throughout this description, can include direct or indirect connections, including connections without direct physical contact, electrical connections, optical connections, and so on.

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, or C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof. While various applications of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various applications be implemented to perform the recited functionality in the same order, and with each of the steps shown, unless the context dictates otherwise.

Although the disclosed technology is described above in terms of various exemplary applications and implementations, it should be understood that the various features, aspects and functionality described in one or more of the individual applications are not limited in their applicability to the particular application with which they are described, but instead can be applied, alone or in various combinations, to one or more of the other applications of the disclosed technology, whether or not such applications are described and whether or not such features are presented as being a part of a described application. Thus, the breadth and scope of the technology disclosed herein should not be limited by any of the above-described exemplary applications.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various applications set forth herein are described in terms of exemplary block diagrams, flow charts and other illustrations. As will become apparent to one of ordinary skill in the art after reading this document, the illustrated applications and their various alternatives can be implemented without confinement to the illustrated examples. For example, block diagrams and their accompanying description should not be construed as mandating a particular architecture or configuration.

1. A computer implemented method for platoon formation, the method comprising:
receiving, from a first vehicle, a first platoon intent message;
determining, from the first platoon intent message, a first location, a first destination, and a first high occupancy lane (HOL) price budget of the first vehicle;
receiving, from a second vehicle, a second platoon intent message;
determining, from the second platoon intent message, a second location, a second destination, and a second HOL price budget of the second vehicle; and
responsive to the first location of the first vehicle being within a location threshold distance of the second location of the second vehicle, the first destination of the first vehicle being within a destination threshold distance of the second destination of the second vehicle, and the first HOL price budget of the first vehicle being within a budget threshold amount of the second HOL price budget of the second vehicle, autonomously moving the first vehicle and the second vehicle into a formation as a platoon.

2. The method of claim 1, wherein the first HOL price budget of the first vehicle and the second HOL price budget of the second vehicle must be above a price threshold for the platoon to be established between the first and second vehicles.

3. The method of claim 1, further comprising generating a platoon formation strategy for the first and second vehicles, wherein the platoon formation strategy comprises one or more instructions for the first and second vehicles to execute to establish the platoon.

4. The method of claim 1, further comprising generating a platoon route for the platoon of vehicles to execute, wherein the platoon route comprises a route for the platoon of vehicles to follow to reach at least one destination of the vehicles in the platoon.

5. The method of claim 4, wherein the platoon route is generated according to at least one factor of safety, energy efficiency, road capacity, or comfort.

6. The method of claim 5, wherein at least one of the factors of safety, energy efficiency, or road capacity is based on capabilities of the vehicles in the platoon and the location of the platoon of vehicles.

7. The method of claim 1, further comprising:
determining a HOL is available for the platoon to travel on, wherein the HOL has a HOL price;
determining the first vehicle and the second vehicle in the platoon have a respective HOL price budget that exceeds the HOL price of the HOL; and
autonomously moving the first vehicle and the second vehicle in the platoon to travel on the HOL.

8. The method of claim 7, wherein the first HOL price budget of the first vehicle and the second HOL price budget of the second vehicle in the platoon traveling on the HOL are decreased as the first vehicle and the second vehicle travel on the HOL.

9. The method of claim 1, further comprising:
determining a given vehicle in the platoon is to disengage from the platoon; and
updating a platoon formation strategy for each remaining vehicle in the platoon to execute to reestablish the platoon upon separation of the disengaged vehicle.

10. A computing system for platoon formation comprising:
one or more processors; and
memory coupled to the one or more processors to store instructions, which when executed by the one or more processors, cause the one or more processors to perform operations, the operations comprising:
receiving, from a first vehicle, a first platoon intent message;
determining, from the first platoon intent message, a first location, a first destination, and a first high occupancy lane (HOL) price budget of the first vehicle;
receiving, from a second vehicle, a second platoon intent message;
determining, from the second platoon intent message, a second location, a second destination, and a second HOL price budget of the second vehicle; and
responsive to the first location of the first vehicle being within a location threshold distance of the second location of the second vehicle, the first destination of the first vehicle being within a destination threshold distance of the second destination of the second vehicle, and the first HOL price budget of the first vehicle being within a budget threshold amount of the second HOL price budget of the second vehicle, autonomously moving the first vehicle and the second vehicle into a formation as a platoon.

11. The computing system of claim 10, the operations further comprising generating a platoon formation strategy for the first and second vehicles, wherein the platoon formation strategy comprises one or more instructions for the first and second vehicles to execute to establish the platoon.

12. The computing system of claim 10, the operations further comprising generating a platoon route for the platoon of vehicles to execute, wherein the platoon route comprises a route for the platoon of vehicles to follow to reach at least one destination of the vehicles in the platoon.

13. The computing system of claim 12, wherein the platoon route is generated according to at least one factor of safety, energy efficiency, road capacity, or comfort.

14. The computing system of claim 13, wherein at least one of the factors of safety, energy efficiency, or road capacity is based on capabilities of the vehicles in the platoon and the location of the platoon of vehicles.

15. The computing system of claim 10, the operations further comprising:
determining a HOL is available for the platoon to travel on, wherein the HOL has a HOL price;
determining the first vehicle and the second vehicle in the platoon have a respective HOL price budget that exceeds the HOL price of the HOL; and
autonomously moving the first vehicle and the second vehicle in the platoon to travel on the HOL.

16. The computing system of claim 15, wherein the first HOL price budget of the first vehicle and the second HOL price budget of the second vehicle in the platoon traveling on the HOL are decreased as the first vehicle and the second vehicle travel on the HOL.

17. The computing system of claim 10, the operations further comprising:
determining a given vehicle in the platoon is to disengage from the platoon; and
updating a platoon formation strategy for each remaining vehicle in the platoon to execute to reestablish the platoon upon separation of the disengaged vehicle.

18. A non-transitory machine-readable medium having instructions stored therein, which when executed by a processor, cause the processor to perform operations, the operations comprising:
receiving a first platoon intent message from a first vehicle;
determining a first location, a first destination, and a first high occupancy lane (HOL) price budget of the first vehicle from the first platoon intent message;
receiving a second platoon intent message from a second vehicle;
determining a second location, a second destination, and a second HOL price budget of the second vehicle from the second platoon intent message; and
responsive to the first location of the first vehicle being within a location threshold distance of the second location of the second vehicle, the first destination of the first vehicle being within a destination threshold distance of the second destination of the second vehicle, and the first HOL price budget of the first vehicle being within a budget threshold amount of the second HOL price budget of the second vehicle, autonomously moving the first vehicle and the second vehicle into a formation as a platoon.

19. The non-transitory machine-readable medium of claim 18, the operations further comprising:
determining a HOL is available for the platoon to travel on while the platoon is enroute to reach at least one destination, wherein the HOL has a HOL price;
determining the first vehicle and the second vehicle in the platoon have a respective HOL price budget that exceeds the HOL price of the HOL; and
autonomously moving the first vehicle and the second vehicle in the platoon to travel on the HOL.

20. The non-transitory machine-readable medium of claim 18, the operations further comprising:
determining a given vehicle in the platoon is to disengage from the platoon; and
updating a platoon formation strategy for each remaining vehicle in the platoon to execute to reestablish the platoon upon separation of the disengaged vehicle.
